(19) United States
(12) Patent Application Publication
(10) Pub. No.: US 2024/0138479 A1
(43) Pub. Date: May 2, 2024

(54) DIELECTRICALLY HEATED AEROSOL-GENERATING SYSTEM WITH OPTIMISED DIMENSIONS

(71) Applicant: Philip Morris Products S.A., Neuchatel (CH)

(72) Inventors: Ana Isabel GONZALEZ FLOREZ, St-Sulpice (CH); Roberto MANCINI, Bofflens (CH); Enrico TURRINI, Neuchatel (CH)

(73) Assignee: Philip Morris Products S.A., Neuchatel (CH)

(21) Appl. No.: 18/547,431

(22) PCT Filed: Mar. 2, 2022
(86) PCT No.: PCT/EP2022/055306

§ 371 Date: Aug. 22, 2023

(30) Foreign Application Priority Data
Mar. 2, 2021 (EP) 21160319.6

(51) Int. Cl. A24F 40/46; A24D 1/20; A24F 1/30; A24F 40/20; A24F 40/57; H05B 6/50; H05B 6/54; H05B 6/62

(52) U.S. Cl. CPC A24F 40/46; A24D 1/20; A24F 1/30; A24F 40/20; A24F 40/57; H05B 6/50; H05B 6/54; H05B 6/62

(57) ABSTRACT

A dielectrically heatable aerosol-generating system is provided, including: an aerosol-forming substrate; a first electrode and a second electrode; and an aerosol-generating device including a controller configured to connect to the first electrode and the second electrode, in which the first electrode and the second electrode form a capacitor with a portion of the aerosol-forming substrate, in which the controller is further configured to supply an alternating voltage to the first electrode and the second electrode for dielectrically heating the aerosol-forming substrate, and in which the first electrode and the second electrode are configured to be spaced apart by a separation distance of between about 4 millimeters and about 9 millimeters. An aerosol-generating article for a dielectrically heated aerosol-generating system is also provided.

The present disclosure relates to an aerosol-generating system for dielectrically heating an aerosol-forming substrate. The present disclosure also relates to an aerosol-generating device for use in the system and an aerosol-generating article for use with an aerosol-generating device. In particular, the present disclosure relates to a shisha system, a shisha device and an aerosol-generating article for use with a shisha device.

Aerosol-generating systems comprising an electrically operated aerosol-generating device that are configured to heat an aerosol-forming substrate are known in the art. For example, shisha systems comprising an electrically operated shisha device that is configured to heat a shisha aerosol-forming substrate have been proposed.

Known electrically operated aerosol-generating systems heat an aerosol-forming substrate by one or more of: conduction of heat from a heating element to an aerosol-forming substrate, radiation of heat from a heating element to an aerosol-forming substrate or drawing heated air through an aerosol-forming substrate. Most commonly, heating is achieved by passing an electrical current through an electrically resistive heating element, giving rise to Joule heating of the heating element. Inductive heating systems have also been proposed, in which Joule heating occurs as a result of eddy currents induced in a susceptor heating element.

One problem with previously proposed electrically operated aerosol-generating devices is that they may give rise to non-uniform heating of the aerosol-forming substrate. The portion of the aerosol-forming substrate closest to the heating element is heated more quickly or to a higher temperature than portions of the aerosol-forming substrate more remote from the heating element.

It would be desirable to be able to provide uniform heating of an aerosol-forming substrate, in an electrically heated aerosol-generating system, in a manner that allows for greater design flexibility and that allows for heating control.

It would also be desirable to provide an optimised electrically operated aerosol-generating system that is configured to heat an aerosol-forming substrate in a manner that is power efficient and provides a user with an improved experience.

In this disclosure there is provided a dielectrically heated aerosol-generating system. The aerosol-generating system may comprise an aerosol-forming substrate. The aerosol-generating system may comprise a first electrode. The aerosol-generating system may comprise a second electrode. The aerosol-generating system may comprise an aerosol-generating device. The aerosol-generating device may comprise for a controller configured to connect to the first electrode and the second electrode. The first electrode and the second electrode may form a capacitor with a portion of the aerosol-forming substrate. The controller may be configured to supply an alternating voltage to the first electrode and the second electrode for dielectrically heating the aerosol-forming substrate.

Such an aerosol-generating system is configured to give rise to dielectric heating of the aerosol-forming substrate due to the alternating electromagnetic field between the first electrode and the second electrode on supply of the alternating voltage to the first electrode and the second electrode. Dielectric heating can be uniform within a volume of aerosol-forming substrate, without the creation of hot spots. In particular, dielectric heating reduces the likelihood of combustion of substrate in contact with the first electrode and the second electrode compared to a conventional heater that transfers heat to the substrate via conduction.

In some preferred embodiments, the first electrode and the second electrode may be configured to be spaced apart by a separation distance of between about 2 millimeters and about 9 millimeters.

As used herein, the term ‘separation distance’ is the minimum distance between opposing surfaces of the first electrode and the second electrode.

In some particularly preferred embodiments of this disclosure, there is provided a dielectrically heated aerosol-generating system. The aerosol-generating system comprises an aerosol-forming substrate. The aerosol-generating system further comprises a first electrode, and a second electrode. The aerosol-generating system further comprises an aerosol-generating device comprising a controller configured to connect to the first electrode and the second electrode. The first electrode and the second electrode form a capacitor with a portion of the aerosol-forming substrate. The controller is configured to supply an alternating voltage to the first electrode and the second electrode for dielectrically heating the aerosol-forming substrate. The first electrode and the second electrode are configured to be spaced apart by a separation distance of between about 2 millimeters and about 9 millimeters.

The electromagnetic field strength between the first electrode and the second electrode is dependent on the separation distance between the first electrode and the second electrode. A separation distance of between about 2 millimeters and about 9 millimeters is advantageous when dielectric heating is used to heat an aerosol-forming substrate. Such a separation distance provides optimum electromagnetic field strength per unit area for heating an aerosol-forming substrate. Such a separation distance also enables an optimum thickness of aerosol-forming substrate to be maintained between the first electrode and the second electrode for dielectric heating resulting in optimised heating and aerosol production.

Such a separation distance also enables the system to efficiently use electrical power. Efficient electrical power usage is advantageous because, for example, in a battery powered system, this may lead to longer usage sessions. Efficient electrical power usage is also advantageous because, for example, it may result in reduced cost to the user per usage session.

In some preferred embodiments, the first electrode may have a first length. The second electrode may have a second length. The second length may be substantially the same as the first length. The first electrode and the second electrode may be configured to be spaced apart in a direction perpendicular to the first length and the second length by a separation distance. A ratio between the length of the first electrode and the separation distance may be configured to be between about 1 and about 120. For example, the ratio may be between about 1 and about 110, between about 1 and about 100, between about 1 and about 90, between about 1 and about 80, between about 1 and about 70, between about 1 and about 60, between about 1 and about 50, between about 1 and about 40, between about 1 and about 30, between about 1 and about 25, between about 5 and about 25, between about 5 and about 20, between about 10 and about 20. In some particularly preferred embodiments, the ratio between the length of the first electrode and the separation distance may be configured to be between about 10.5 and about 19.5.

Various notations for expressing ratios are known to the skilled person. For example, and purely for illustrating alternative ratio notations, the length of the first electrode may be 22 mm and the separation distance may be 2 mm, resulting in the ratio of the first length of the electrode to the separation distance of 11. Alterative notations expressing such a ratio may include 22:2 (11:1), 22/2 (11/1) or 11.

As used herein, the term ‘length’ refers to the maximum longitudinal dimension of an aerosol-generating device, a component of the aerosol-generating device, an aerosol-generating article or a component of an aerosol-generating article.

In some particularly preferred embodiments of this disclosure, there is provided a dielectrically heated aerosol-generating system. The aerosol-generating system comprises an aerosol-forming substrate. The aerosol-generating system further comprises a first electrode, and a second electrode. The aerosol-generating system further comprises an aerosol-generating device comprising a controller configured to connect to the first electrode and the second electrode. The first electrode and the second electrode form a capacitor with a portion of the aerosol-forming substrate. The controller is configured to supply an alternating voltage to the first electrode and the second electrode for dielectrically heating the aerosol-forming substrate. The first electrode has a first length, and the second electrode has a second length. The second length is substantially the same as the first length. The first electrode and the second electrode are configured to be spaced apart in a direction perpendicular to the first length and the second length by a separation distance. A ratio between the length of the first electrode and the separation distance is configured to be between about 10.5 and about 19.5.

A ratio between the length of the first electrode and the separation distance of between about 10.5 and about 19.5 maintains optimal generation of aerosol from the aerosol-forming substrate as the size of the device is scaled. As the device is scaled, the length of the first electrode and the second electrode, and the separation distance between the electrodes, may vary in order to accommodate different dimensions and quantities of aerosol-forming substrate. For example, in a handheld portable device designed for a single user, the length of the electrodes and the separation distance between them may be reduced compared to a device that is design to be placed on a table and used by multiple users at once. The length of the electrodes and the separation distance between them may be reduced because the quantity of aerosol-forming substrate used per usage session is reduced in the two devices.

In some embodiments, the ratio between the length of the first electrode and the separation distance may be configured to be between about 11 and about 19. In preferred embodiments, the ratio between the length of the first electrode and the separation distance may be configured to be between about 11.5 and about 18.5. In more preferred embodiments, the ratio between the length of the first electrode and the separation distance may be configured to be between about 15.5 and about 17.5. In exemplary embodiments, the ratio between the length of the first electrode and the separation distance may be configured to be about 16.6 or about 16.7.

In some embodiments, the first electrode and the second electrode are configured to be spaced apart by a separation distance of between about 0.1 millimeters and about 9 millimeters. In some embodiments, the separation distance may be configured to be about 0.1 millimeters, about 0.2 millimeters, about 0.3 millimeters, about 0.4 millimeters, about 0.5 millimeters, about 0.6 millimeters, about 0.7 millimeters, about 0.8 millimeters, about 0.9 millimeters, about 1 millimeters, about 2 millimeters, about 3 millimeters, about 4 millimeters, about 5 millimeters, about 6 millimeters, about 7 millimeters, about 8 millimeters or about 9 millimeters.

In some preferred embodiments, the separation distance may be configured to be about 2 millimeters, about 3 millimeters, about 4 millimeters, about 5 millimeters, about 6 millimeters, about 7 millimeters, about 8 millimeters or about 9 millimeters.

In some preferred embodiments, the separation distance may be configured to be between about 2 millimeters and about 9 millimeters. In some embodiments, the separation distance may be configured to be between about 2 millimeters and about 6 millimeters. Preferably, the separation distance may be configured to be between about 2 millimeters and about 4 millimeters. More preferably, the separation distance may be about 3 millimeters.

In some embodiments, the separation distance may be configured to be between about 4 millimeters and about 9 millimeters. In some embodiments, the separation distance may be configured to be between about 5 millimeters and about 9 millimeters. In some embodiments, the separation distance may be configured to be between about 5 millimeters and about 8 millimeters. In some embodiments, the separation distance may be configured to be between about 5 millimeters and about 7 millimeters.

In some embodiments, the separation distance is dependent on the type of aerosol-forming substrates configured for use with the aerosol-generating system.

In embodiments for use with aerosol-forming substrates that are shisha substrates, which are described in more detail below, the first electrode and the second electrode are configured to be spaced apart by a separation distance of between about 2 millimeters and about 9 millimeters. In some embodiments, the separation distance may be configured to be between about 2 millimeters and about 6 millimeters. Preferably, the separation distance may be configured to be between about 2 millimeters and about 4 millimeters. More preferably, the separation distance may be configured to be about 3 millimeters. In some embodiments, the separation distance may be configured to be about 2 millimeters, about 3 millimeters, about 4 millimeters, about 5 millimeters, about 6 millimeters, about 7 millimeters, about 8 millimeters or about 9 millimeters.

In embodiments for use with non-shisha substrates, the first electrode and the second electrode are configured to be spaced apart by a separation distance of between about 0.1 millimeters and about 9 millimeters. For example, between about 0.1 millimeters and about 8 millimeters, between about 0.1 millimeters and about 7 millimeters, between about 0.1 millimeters and about 6 millimeters, between about 0.5 millimeters and about 6 millimeters, between about 1 millimeter and about 6 millimeters, between about 1 millimeter and about 5 millimeters, between about 1 millimeter and about 4 millimeters between about 1 millimeter and about 3 millimeters, between about 2 millimeters and about 3 millimeters.

In some embodiments, the length of the first electrode may be between about 20 millimeters and about 60 millimeters. In some embodiments, the length of the first electrode may be between about 25 millimeters and about 60 millimeters. In some embodiments, the length of the first electrode may be between about 30 millimeters and about 60 millimeters. In some embodiments, the length of the first electrode may be between about 30 millimeters and about 55 millimeters. In some embodiments, the length of the first electrode may be between about 35 millimeters and about 55 millimeters. In some embodiments, the length of the first electrode may be between about 40 millimeters and about 55 millimeters. Preferably, the length of the first electrode may be between about 45 millimeters and about 55 millimeters. For example, the length of the first electrode may be about 46 millimeters, about 47 millimeters, about 48 millimeters, about 49 millimeters, about 50 millimeters, about 51 millimeters, about 52 millimeters, about 53 millimeters, about 54 millimeters. In a preferred embodiment, the length of the first electrode may be about 50 millimeters.

The length of the electrodes, in part, determines the amount of the aerosol-forming substrate that is to be heated. Heating an amount of aerosol-forming substrate that is too small or too large may provide an undesirable experience to a user, for example, by producing an undesirable quantity or quality of aerosol. The length of the electrodes themselves also determines the power required in order to develop an electromagnetic field between them. The length dimensions provided in this disclosure are optimised for power efficient dielectric heating of an aerosol-forming substrate.

As used herein, the term ‘thickness’ refers to the maximum transverse dimension of an aerosol-generating device, a component of the aerosol-generating device, an aerosol-generating article or a component of an aerosol-generating article. A transverse dimension is a dimension measured in a direction orthogonal to a longitudinal direction, the longitudinal direction being the direction in which length is measured.

In some embodiments, the first electrode may have a thickness of between about 0.02 millimeters and about 2 millimeters. Preferably, the first electrode may have a thickness of between about 0.1 millimeters and about 1 millimeter. Most preferably, the first electrode may have a thickness of between about 0.3 millimeters and about 0.5 millimeters. In some embodiments, the second electrode may have a thickness of between about 0.02 millimeters and about 2 millimeters. Preferably, the second electrode may have a thickness of between about 0.1 millimeters and about 1 millimeter. Most preferably, the second electrode may have a thickness of between about 0.3 millimeters and about 0.5 millimeters. In preferred embodiments, the thickness of the first electrode may be substantially the same as the thickness of the second electrode.

When the first and second electrodes are not sufficiently thick, it may be difficult to maintain alignment of the electrodes relative to one another, for example, it may be difficult to ensure the first and second electrodes remain parallel. When the electrodes are too thick, they may act as heatsinks and, as a consequence, lower the thermal efficiency of the system, resulting in increased power requirements and reduced power efficiency.

In the system of this disclosure, the first electrode and the second electrode may be arranged in any suitable manner. In some embodiments, the aerosol-generating device comprises the first electrode and the second electrode. In some embodiments, the aerosol-generating system comprises an aerosol-generating article comprising the aerosol-forming substrate, and the aerosol-generating article further comprises the first electrode and the second electrode. In some embodiments, the aerosol-generating system comprises an aerosol-generating article comprising the aerosol-forming substrate, the aerosol-generating device comprises one of the first electrode and the second electrode, and the aerosol-generating article comprises the other one of the first electrode and the second electrode.

As used herein, the term “aerosol-forming substrate” relates to a substrate capable of releasing volatile compounds that can form an aerosol. Such volatile compounds may be released by heating the aerosol-forming substrate. An aerosol-forming substrate is typically part of an aerosol-generating article.

As used herein, the term “aerosol-generating article” refers to an article comprising an aerosol-forming substrate that is capable of releasing volatile compounds that can form an aerosol. For example, an aerosol-generating article may be an article that generates an aerosol that is directly inhalable by the user drawing or puffing on a mouthpiece. An aerosol-generating article may be disposable. An article comprising an aerosol-forming substrate comprising tobacco may be referred to as a tobacco stick.

As used herein, the term “aerosol-generating device” refers to a device that interacts with an aerosol-forming substrate to generate an aerosol. An aerosol-generating article is separate from and configured for combination with an aerosol-generating device for heating the aerosol-generating article.

As used herein, the term “aerosol-generating system” refers to the combination of an aerosol-generating device with an aerosol-forming substrate. In the aerosol-generating system, the aerosol-forming substrate and the aerosol-generating device cooperate to generate an aerosol.

The aerosol-generating system comprises an aerosol-generating device.

In this disclosure, there is also provided a dielectrically heated aerosol-generating device. The aerosol-generating device comprises a first electrode and a second electrode. The aerosol-generating device further comprises a controller connected to the first electrode and the second electrode. The device is configured to receive an aerosol-forming substrate. The first electrode and the second electrode form a capacitor with at least a portion of the aerosol-forming substrate. The controller is configured to supply an alternating voltage to the first electrode and the second electrode for dielectrically heating the aerosol-forming substrate.

The aerosol-generating system comprises an aerosol-forming substrate. In some preferred embodiments, the aerosol-generating system comprises an aerosol-generating article comprising the aerosol-forming substrate. The aerosol-generating device may be configured to receive the aerosol-generating article. The aerosol-generating device may comprise an article cavity configured to receive at least a portion of the aerosol-generating article.

In this disclosure, there is also provided an aerosol-generating article for a dielectrically heated aerosol-generating system. The aerosol-generating article comprises an aerosol-forming substrate. The aerosol-generating article comprises a first electrode and a second electrode, the first electrode and the second electrode being spaced apart to form a substrate cavity. The aerosol-forming substrate is disposed in the substrate cavity between the first electrode and the second electrode.

In aerosol-generating systems in which an aerosol-generating article is provided, and the aerosol-generating article comprises at least one of the first electrode and the second electrode, the aerosol-generating device may comprise at least one electrical contact. The electrical contact of the aerosol-generating device may be arranged to electrically connect with the electrode of the aerosol-generating article. Where the aerosol-generating article comprises the first electrode and the second electrode, the aerosol-generating device may comprise a plurality of electrical contacts. The electrical contacts of the aerosol-generating device may be arranged to electrically connect with the first electrode and the second electrode of the aerosol-generating article when the aerosol-generating article is received by the aerosol-generating device.

In aerosol-generating systems in which an aerosol-generating article is provided, and the aerosol-generating device comprises an article cavity configured to receive at least a portion of the aerosol-generating article, at least a portion of the aerosol-forming substrate may be located in the article cavity when at least a portion of the article is received in the cavity. The first electrode and the second electrode may also be located in the article cavity when at least a portion of the article is received in the article cavity. At least a portion of the aerosol-forming substrate may be received between the first electrode and the second electrode when at least a portion of the article is received in the article cavity. Where the aerosol-generating article comprises at least one electrode, and the aerosol-generating device comprises at least one electrical contact configured to electrically connect to the electrode of the aerosol-generating article, the at least one electrical contact may be arranged in the article cavity.

Where the aerosol-generating article comprises the first electrode and the second electrode, the first electrode and the second electrode may be arranged at opposite sides of the article. Where the aerosol-generating device comprises the first electrode and the second electrode, and an article cavity, the first electrode and the second electrode may be arranged at opposite sides of the article cavity. The second electrode may be directly opposite the first electrode. In other words, the second electrode may be arranged facing the first electrode. The second electrode may be arranged opposite and facing the first electrode.

The first electrode and the second electrode form a capacitor. The capacitor may comprise the first electrode, the second electrode and a portion of the aerosol-forming substrate. The aerosol-forming substrate may be arranged between the first electrode and the second electrode. In some embodiments, only the aerosol-forming substrate is arranged between the first electrode and the second electrode. In other words, the aerosol-forming substrate may be arranged directly between the first electrode and the second electrode without any other intervening components. In some embodiments, the aerosol-forming substrate and one or more other components are arranged between the first electrode and the second electrode. In other words, the aerosol-forming substrate may be indirectly arranged between the first and second electrode, with one or more additional, intervening components arranged between at least one of the electrodes and the aerosol-forming substrate. For example, in some embodiments, the aerosol-generating system may comprise an aerosol-generating article comprising the aerosol-forming substrate and a wrapper circumscribing the aerosol-forming substrate. In these embodiments, at least a portion of the aerosol-generating article may be arranged between the first electrode and the second electrode. In these embodiments, at least a portion of the aerosol-forming substrate and at least a portion of the wrapper may be arranged between the first electrode and the second electrode.

The aerosol-forming substrate may comprise one or more dielectric materials. The aerosol-forming substrate may be a dielectric material. The components arranged between the first electrode and the second electrode may comprise dielectric materials. The components arranged between the first electrode and the second electrode may be dielectric materials.

The aerosol-generating device comprises a controller configured to connect to the first electrode and the second electrode. The controller is configured to supply the alternating voltage to the first electrode and the second electrode. In some embodiments, the first electrode may comprise a first surface. Where the aerosol-generating device comprises the first electrode, and an article cavity, the first surface of the first electrode may define a first surface of the article cavity. The second electrode may comprise a second surface. Where the aerosol-generating device comprises the first electrode, and an article cavity, the first surface of the first electrode may define a second surface of the article cavity. In some embodiments, the surface area of the first surface may be between about 5 millimeters squared and about 3000 millimeters squared. In some preferred embodiments, the surface area of the first surface may be between about 20 millimeters squared and about 2000 millimeters squared. In some embodiments, the surface area of the second surface may be between about 5 millimeters squared and about 1000 millimeters squared. In some preferred embodiments, the surface area of the second surface may be between about 20 millimeters squared and about 500 millimeters squared. In exemplary embodiments, the surface area of the first surface may be substantially the same as the surface area of the second surface.

The surface area of the electrode surfaces is a factor that determines the electromagnetic field strength between them and, thus, the extent of dielectric heating. The surface area of the electrodes also, in part, determines the amount of the aerosol-forming substrate that is heated.

The first electrode and the second electrode are electrically conductive. The first electrode and the second electrode may comprise an electrically conductive material, such as a metal.

In some preferred embodiments, the first electrode may be substantially identical to the second electrode. In some embodiments, each of the electrodes has a shape that is one of: rectangular, square, pentagonal, hexagonal or triangular.

In some preferred embodiments, the first electrode is substantially planar, and the second electrode is substantially planar. The first electrode may extend substantially in a first plane, and the second electrode may extend substantially in a second plane. The first plane may be substantially parallel to the second plane. A substantially planar electrode may have a substantially elliptical, circular, square, rectangular or any other polygonal shape.

In some embodiments, the first electrode may circumscribe the second electrode. In some embodiments, the second electrode may circumscribe the first electrode. In some preferred embodiments, the first electrode may be substantially coaxial with the second electrode. In some particularly preferred embodiments, the first electrode and the second electrode may be substantially cylindrical.

In some embodiments, the first electrode may be annular, and define an internal passage. The second electrode may be disposed in the internal passage of the first electrode. The first electrode and the second electrode may be disposed coaxially along a longitudinal axis.

Co-axial electrodes may permit the separation distance between the first electrode and the second electrode to be maintained, while also permitting an increased quantity of aerosol-forming substrate to be arranged between the electrodes, without substantially increasing the size of the device, when compared to planar electrodes.

In some embodiments, at least one of the first electrode and the second electrode may be gas permeable, to enable air to flow through the electrode. In some embodiments, at least a portion of at least one of the first electrode and the second electrode may be formed from a gas permeable material. In some embodiments, one or more slots are formed in at least one of the first electrode and the second electrode. The one or more slots may have any shape, size, number and arrangement to enable sufficient air to flow through the electrode. In some embodiments, the one or more slots have a shape that is one of: square, rectangular, circular, cross-shaped, pentagonal, hexagonal or any other polygonal shape.

In some embodiments in which the aerosol-generating device comprises an article cavity, the article cavity may have a substantially cylindrical shape. In some preferred embodiments, the article cavity may have a substantially annular cylindrical shape. The annular cylindrical article cavity may have a curved outer surface. The annular cylindrical article cavity may have a passage extending through the article cavity defined by an inner surface. One of the first electrode and the second electrode may be arranged at the curved outer surface. One of the first electrode and the second electrode may be arranged at the curved outer surface when the aerosol-generating article is received in the article cavity. The other one of the first electrode and the second electrode may be arranged at the inner surface. The other one of the first electrode and the second electrode may be arranged at the inner surface when the aerosol-generating article is received in the article cavity. In some embodiments, the electrode arranged at the outer surface of the article cavity substantially circumscribes the aerosol-forming substrate when the aerosol-generating article is received in the article cavity. The article cavity may be gas permeable in a direction extending between the inner surface and the curved outer surface.

An annular article cavity may permit the separation distance of the electrodes to be maintained while also permitting an increased quantity of aerosol-forming substrate, without substantially increasing the size of the device.

The frequency of the alternating voltage supplied to the first electrode and the second electrode for dielectrically heating the aerosol-forming substrate may depend on factors such as the separation distance and the aerosol-forming substrate properties. In some embodiments, the frequency of the alternating voltage supplied to the first electrode and the second electrode may be between 10 megahertz and 100 megahertz, preferably between about 10 megahertz and about 80 megahertz, more preferably between about 10 megahertz and about 40 megahertz, more preferably between about 10 megahertz and about 30 megahertz. In a preferred embodiment, the frequency of the alternating voltage supplied to the first electrode and the second electrode may be about 20 megahertz. The alternating voltage supplied to the first electrode and the second electrode may be a radio frequency (RF) alternating voltage. As used herein, the term ‘radio frequency (RF) alternating voltage’ refers to an alternating voltage that alternates at a frequency within the radio frequency (RF) range. As used herein, radio frequency (RF) means a frequency between about 20 kilohertz (kHz) and about 300 megahertz (MHz). Accordingly, as used herein, RF frequencies include microwave frequencies.

The aerosol-generating device comprises a controller. The controller may comprise a microprocessor, a programmable microprocessor, a microcontroller, or an application specific integrated chip (ASIC) or other electronic circuitry capable of providing control. The controller may comprise further electronic components. For example, in some embodiments, the controller may comprise any of: sensors, switches, display elements. The controller may comprise an RF power sensor. The controller may comprise a power amplifier.

In embodiments in which the controller has a memory, the memory may be volatile memory. In some embodiments, the memory may be non-volatile memory. Non-volatile memory may advantageously allow the aerosol-generating system to store parameters between usage sessions of the aerosol-generating system, when power is not supplied to the controller.

The aerosol-generating device may comprise a power supply. The power supply may supply the alternating voltage to the first electrode and the second electrode for heating the aerosol-forming substrate. The power supply may be a rechargeable power supply. The power supply may be a DC power supply. The power supply may comprise at least one battery. The at least one battery may include a rechargeable lithium-ion battery. As an alternative, the power supply may be another form of charge storage device, such as a capacitor.

The aerosol-generating device may be configured to be connected to an external power source for recharging the rechargeable power source. In some embodiments, the aerosol-generating device is configured to be connected to an external power source. For example, the aerosol-generating device may be configured to be connected to a mains power source.

The power supply may provide a power of between about 10 Watts and about 60 Watts to the first electrode and the second electrode.

Where the power supply is a DC power supply, the aerosol-generating device may further comprise a DC/AC converter. The DC/AC converter may be arranged to convert a DC voltage from the DC power supply to an AC voltage, which may be directly or indirectly supplied to the first electrode and the second electrode.

The aerosol-generating device may comprise a puff detector configured to detect when a user takes a puff on the aerosol-generating system. As used herein, the term “puff” is used to refer to a user drawing on the aerosol-generating system to receive aerosol. The puff detector may comprise a temperature sensor. The puff detector may comprise a pressure sensor. The puff detector may comprise both a temperature sensor and a pressure sensor. Where the aerosol-generating device comprises a puff detector, the controller may be configured to supply the alternating voltage to the first electrode and the second electrode for heating the aerosol-forming substrate when a puff is detected by the puff detector.

The aerosol-generating device may comprise an oscillation circuit. The oscillation circuit may be arranged to supply the alternating voltage to the first electrode and the second electrode for heating the aerosol-forming substrate. The oscillation circuit may be connected to the controller. The controller may be configured to control the oscillation circuit.

The oscillation circuitry may comprise a radio frequency (RF) signal generator. The RF signal generator may be any suitable type of RF signal generator. In some embodiments, the RF signal generator is a solid-state RF transistor. Advantageously, a solid-state RF transistor may be configured to generate and amplify the RF electromagnetic field. Using a single transistor to provide both the generating and amplification of the RF electromagnetic field allows for an aerosol-generating device to be compact. The solid-state RF transistor may be, for example, a LDMOS transistor, a GaAs FET, a SiC MESFET or a GaN HFET.

In some embodiments, the oscillation circuitry may further comprise a frequency synthesizer disposed between the RF signal generator and the first electrode and the second electrode.

In some embodiments, the oscillation circuitry may further comprise a phase shift network disposed between the RF signal generator and the first electrode and the second electrode. Where the oscillation circuitry comprises a phase shift network, the phase shift network divides the RF energy received from the RF signal generator into two separate, equal components that are out of phase with each other. Typically, the phase shift network supplies one of the components to the first electrode, and supplies the other component to the second electrode. The two substantially equal components of the RF energy received from the RF signal generator are preferably substantially 90 degrees or 180 degrees out of phase with each other. The two substantially equal components may be any multiple of 90 degrees or 180 degrees out of phase with each other. It will be appreciated that the precise phase relationship between the two components is not essential, but rather that the two components are not in phase.

In some embodiments, the phase shift network is configured to divide the RF energy from the RF signal generator into two substantially equal components, one out of phase with the other, and each component is applied to a different one of the first electrode and the second electrode.

Preferably, the aerosol-generating device is portable. The aerosol-generating device may have a size comparable to a conventional cigar or cigarette. The aerosol-generating device may have a total length between about 30 millimeters and about 150 millimeters. The aerosol-generating device may have an outer diameter between about 5 millimeters and about 30 millimeters. The substrate cavity may have a diameter between 2 millimeters and 20 millimeters. The substrate cavity may have a length between 2 millimeters and 20 millimeters. The aerosol-generating device may be a personal vaporiser, an e-cigarette or heat-not-burn device.

In embodiments comprising an aerosol-generating article, the aerosol-generating article may take any suitable form.

The aerosol-generating article comprises the aerosol-forming substrate. In some preferred embodiments, the aerosol-generating article comprises one or both of the first electrode and the second electrode. The aerosol-generating article may have one or more additional components. For example, the aerosol-generating article may have a mouthpiece, such as a mouthpiece filter. The aerosol-generating article may have at least one of a cooling element and a spacing element.

In some preferred embodiments, the aerosol-generating article comprises a rod. The rod may be similar to a conventional cigarette or other smoking article.

In some embodiments, the aerosol-forming substrate is circumscribed by a wrapper. The wrapper may be a housing or a container. Providing a wrapper that circumscribes the aerosol-forming substrate may result in no, or a reduced, need to clean an aerosol-generating device that has received the aerosol-generating article. For example, in conventional aerosol-generating devices, during heating of the aerosol-forming substrate, residue may build up in an article cavity or on a heating element of a device. In some embodiments, the wrapper is configured to be pierced when inserted into the aerosol-generating device in order to permit airflow through the aerosol-forming substrate.

In some embodiments, the aerosol-forming substrate is circumscribed by a gas permeable wrapper. A gas permeable wrapper may permit airflow through the aerosol-generating article. The gas permeable wrapper may be configured to permit airflow through the aerosol-generating article in a particular direction. For example, a first portion of the wrapper may be gas permeable, a second portion of the wrapper may be gas permeable, and a third portion of the wrapper may be gas impermeable. In use, airflow may enter the aerosol-forming substrate through the first portion of the wrapper that is gas permeable, and the airflow may exit the aerosol-forming substrate through the second portion of the wrapper that is gas permeable. That is, an airflow path may exist between the first portion of the wrapper that is gas permeable and a second portion of the wrapper that is gas permeable.

In some embodiments, the gas permeable wrapper may be electrically insulating. An electrically insulating gas permeable wrapper may ensure that the first electrode and the second electrode do not come into electrical contact. The gas permeable wrapper may comprise an electrically insulative material.

As used herein, ‘electrically conductive’ means formed from a material having a resistivity of 1×10\hat{ }−4 Ohm meter, or less. As used herein, ‘electrically insulative’ means formed from a material having a resistivity of 1×10\hat{ }4 Ohm meter or more.

In some embodiments in which the aerosol-generating article comprises the first electrode and the second electrode, the first electrode and the second electrode may be disposed at an outer surface of the aerosol-generating article. In some embodiments, the gas permeable wrapper may be disposed between the first electrode and the second electrode.

In some embodiments, at least one of the first electrode and the second electrode may form at least a portion of the gas permeable wrapper. At least one of the first electrode and the second electrode forming at least a portion of the gas permeable wrapper may simplify manufacturing and reduce material costs.

The gas permeable wrapper may be formed from any suitable material. In some preferred embodiments, the gas permeable wrapper may comprise at least one of a cellulose-based material, polypropylene and polyethylene. Where at least one of the first electrode and the second electrode forms at least a portion of the gas permeable wrapper, those portions of the gas permeable wrapper comprise an electrically conductive material, such as a metal.

It may be advantageous to control the airflow through the aerosol-generating article. The airflow through the aerosol-generating article may be controlled passively, such as by defining an airflow path through the article. Controlling the airflow may result in improved airflow through the aerosol-forming substrate, subsequently resulting in improved aerosol production. In some embodiments, a first outer portion the aerosol-generating article may be gas permeable and a second outer portion the aerosol-generating article may be gas permeable. An airflow path may extend through the aerosol-generating article between the first outer portion of the aerosol-generating article and the second outer portion of the aerosol-generating article. Remaining outer portions of the aerosol-generating may be substantially gas impermeable. The airflow path may extend through at least a portion of the aerosol-forming substrate. Where the aerosol-generating device comprises an article cavity, and when the aerosol-generating article is received in the article cavity of the aerosol-generating device, the airflow path of the aerosol-generating article may define a portion of the airflow path through the aerosol-generating system. The airflow path may extend between a mouthpiece of the aerosol-generating system and an air inlet of the aerosol-generating device.

In some embodiments, the aerosol-generating article is gas permeable in a first direction and substantially gas impermeable in a second direction, perpendicular to the first direction. In some embodiments, the aerosol-generating article is gas permeable in a transverse direction and substantially gas impermeable in a longitudinal direction, perpendicular to the transverse direction. The first outer portion of the aerosol-generating article may be a first outer surface and the second outer portion may be a second outer surface. The first outer surface may oppose the second outer surface. The first electrode may be disposed at the first outer surface. The second electrode may be disposed at the second outer surface. At least a portion of the aerosol-forming substrate may be disposed between the first outer surface and the second outer surface. At least a portion of the aerosol-forming substrate may be disposed between the first electrode and the second electrode. An airflow path may extend between the first outer surface and the second outer surface.

In some embodiments, the aerosol-generating article has a thickness of between about 2 millimeters and about 10 millimeters. The thickness of the aerosol-generating article may be between about 3 millimeters and about 9 millimeters, or between about 4 millimeters and about 8 millimeters.

In some embodiments in which the aerosol-generating article comprises the first electrode and the second electrode, a portion of aerosol-forming substrate is disposed between the first electrode and the second electrode. The first electrode, the second electrode and the portion of aerosol-forming substrate disposed between the first electrode and the second electrode may form a capacitor.

The aerosol-generating article may have any suitable shape. Where the aerosol-generating device comprises an article cavity, the aerosol-generating article may have a shape that corresponds to the shape of the article cavity of an aerosol-generating device.

In some embodiments, the aerosol-generating article may be substantially disc shaped.

In some embodiments, the aerosol-generating article may have the shape of a prism. The aerosol-generating article may have a first planar outer surface having a first shape. The aerosol-generating article may have a second planar outer surface having a second shape. The first shape may be substantially identical to the second shape. The first planar outer surface may oppose the second planar outer surface. The aerosol-generating article may have a constant cross-sectional shape between the first planar outer surface and the second planar outer surface. The constant cross-sectional shape may be substantially identical to the first shape and the second shape. The first electrode may be disposed at the first planar outer surface and the second electrode may be disposed at the second planar outer surface. The first electrode may be the first planar outer surface. The second electrode may be the second planar outer surface.

In some embodiments, the first electrode may be arranged at a first end of the aerosol-generating article. The second electrode may be arranged at a second end of the aerosol-generating article, opposite the first end.

In some preferred embodiments, the aerosol-generating article may have a substantially annular cylindrical shape. In some embodiments, the annular cylindrical article has a curved outer surface. The annular cylindrical article may have a passage extending through the article defined by an inner surface. One of the first electrode and the second electrode may be arranged at the curved outer surface. The other one of the first electrode and the second electrode may be arranged at the inner surface. The electrode arranged at the outer surface may substantially circumscribe the aerosol-forming substrate. The aerosol-forming substrate may have a tubular shape. In some embodiments, the aerosol-generating article is gas permeable in a direction extending between the inner surface and the curved outer surface. In some embodiments, a portion the inner surface may be gas permeable, a portion of the outer surface may be gas permeable and the remaining portions of the inner and outer surfaces of the aerosol-generating article may be substantially gas impermeable. An airflow path may extend through the aerosol-generating article between the gas permeable portion of the inner surface and the gas permeable portion of the outer surface. The airflow path may extend through at least a portion of the aerosol-forming substrate. When the aerosol-generating article is received in an article cavity of the aerosol-generating device, the airflow path of the aerosol-generating article may define a portion of an airflow path through the aerosol-generating system. The airflow path may extend between a mouthpiece of the aerosol-generating system and an air inlet of the aerosol-generating device.

The aerosol-forming substrate may take any suitable form. The aerosol-forming substrate may be solid or liquid or comprise both solid and liquid components.

The aerosol-forming substrate may include nicotine. The nicotine containing aerosol-forming substrate may include a nicotine salt matrix. The aerosol-forming substrate may include plant-based material. The aerosol-forming substrate preferably includes tobacco. The tobacco containing material preferably contains volatile tobacco flavour compounds, which are released from the aerosol-forming substrate upon heating. The aerosol-forming substrate may include homogenized tobacco material. Homogenized tobacco material may be formed by agglomerating particulate tobacco. The aerosol-forming substrate may include a non-tobacco-containing material. The aerosol-forming substrate may include homogenized plant-based material.

The aerosol-forming substrate may include, for example, one or more of: powder, granules, pellets, shreds, spaghettis, strips, or sheets. The aerosol-forming substrate may contain one or more of: herb leaf, tobacco leaf, fragments of tobacco ribs, reconstituted tobacco, homogenized tobacco, extruded tobacco, and expanded tobacco. The tobacco may be flue cured.

The aerosol-forming substrate may include at least one aerosol former. Suitable aerosol formers include compounds or mixtures of compounds which, in use, facilitate formation of a dense and stable aerosol and which are substantially resistant to thermal degradation at the operating temperature of the shisha device. Suitable aerosol formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Particularly preferred aerosol formers are polyhydric alcohols or mixtures thereof, such as triethylene glycol, 1,3-butanediol and, most preferred, glycerine. The aerosol-former may be propylene glycol. The aerosol-forming substrate may include any suitable amount of an aerosol former. For example, the aerosol former content of the substrate may be equal to or greater than 5 percent on a dry weight basis, and preferably greater than 30 percent by weight on a dry weight basis. The aerosol former content may be less than about 95 percent on a dry weight basis. Preferably, the aerosol former content is up to about 55 percent on a dry weight basis.

The aerosol-forming substrate preferably includes nicotine and at least one aerosol former. In some embodiments, the aerosol former is glycerine or a mixture of glycerine and one or more other suitable aerosol formers, such as those listed above. In some embodiments, the aerosol-forming is propylene glycol.

In some embodiments, the aerosol-forming substrate may comprise at least one of: water, glycerol, and propylene glycol.

The aerosol-forming substrate may include other additives and ingredients, such as flavourants. In some examples, the aerosol-forming substrate includes one or more sugars in any suitable amount. Preferably, the aerosol-forming substrate includes invert sugar. Invert sugar is a mixture of glucose and fructose obtained by splitting sucrose. Preferably, the aerosol-forming substrate includes between about 1 percent and about 40 percent sugar, such as invert sugar, by weight. In some example, one or more sugars may be mixed with a suitable carrier such as cornstarch or maltodextrin.

In some examples, the aerosol-forming substrate includes one or more sensory-enhancing agents. Suitable sensory-enhancing agents include flavourants and sensation agents, such as cooling agents. Suitable flavourants include natural or synthetic menthol, peppermint, spearmint, coffee, tea, spices (such as cinnamon, clove, ginger, or combination thereof), cocoa, vanilla, fruit flavours, chocolate, eucalyptus, geranium, eugenol, agave, juniper, anethole, linalool, and any combination thereof.

Any suitable amount of aerosol-forming substrate, such as molasses or tobacco substrate, may be provided in the aerosol-generating article. In some preferred embodiments, about 3 grams to about 25 grams of the aerosol-forming substrate is provided in the aerosol-generating article. The cartridge may include at least 6 grams, at least 7 grams, at least 8 grams, or at least 9 grams of aerosol-forming substrate. The cartridge may include up to 15 grams, up to 12 grams; up to 11 grams, or up to 10 grams of aerosol-forming substrate. Preferably, from about 7 grams to about 13 grams of aerosol-forming substrate is provided in the aerosol-generating article.

The aerosol-forming substrate may be provided on or embedded in a thermally stable carrier. The term “thermally stable” is used herein to indicate a material that does not substantially degrade at temperatures to which the substrate is typically heated (e.g., about 150° C. to about 300° C.). The carrier may comprise a thin layer on which the substrate deposited on a first major surface, on second major outer surface, or on both the first and second major surfaces. The carrier may be formed of, for example, a paper, or paper-like material, a non-woven carbon fibre mat, a low mass open mesh metallic screen, or a perforated metallic foil or any other thermally stable polymer matrix. Alternatively, the carrier may take the form of powder, granules, pellets, shreds, spaghettis, strips or sheets. The carrier may be a non-woven fabric or fibre bundle into which tobacco components have been incorporated. The non-woven fabric or fibre bundle may comprise, for example, carbon fibres, natural cellulose fibres, or cellulose-derivative fibres.

In some preferred embodiments, the aerosol-forming substrate may comprise tobacco, sugar and an aerosol-former. In these embodiments, the aerosol-forming substrate may comprise between 10 percent and 40 percent by weight of tobacco. In these embodiments, the aerosol-forming substrate may comprise between 20 percent and 50 percent by weight of sugar. In these embodiments, the aerosol-forming substrate may comprise between 25 percent and 55 percent by weight of aerosol-former. In some particularly preferred embodiments, the aerosol-forming substrate comprises between 20 percent and 30 percent by weight of tobacco, between 30 percent and 40 percent by weight of sugar, and between 35 percent and 45 percent by weight of aerosol-former. In some preferred embodiments, the aerosol-forming substrate may comprise about 25 percent by weight of tobacco, about 35 percent by weight of sugar and about 40 percent by weight of aerosol-former. In some preferred embodiments, the aerosol-forming substrate may comprise between about 15 percent and about 30 percent by weight of tobacco, between about 15 percent and about 30 percent by weight of sugar and between about 45 percent and about 55 percent by weight of aerosol-former. In these preferred embodiments, the tobacco may be flue cured tobacco leaf. In these preferred embodiments, the sugar may be sucrose or invert sugar. In these preferred embodiments, the aerosol-former may be propylene glycol.

In some embodiments, the aerosol-generating system may be a shisha system. In some embodiments, the aerosol-generating device may be a shisha device. The aerosol-generating system may be a shisha system having a shisha device. Shisha devices are different to other aerosol-generating devices, at least in that volatile compounds released from a heated substrate are drawn through a liquid basin of the shisha device before inhalation by a user. A shisha device may include more than one outlet so that the device may be used by more than one user at a time. A shisha device may comprise an airflow conduit, such as a stem pipe, for directing volatile compounds released from the aerosol-forming substrate to the liquid basin.

As used herein, the term “shisha system” refers to the combination of a shisha device with an aerosol-forming substrate or with an aerosol-generating article comprising an aerosol-forming substrate. In the shisha system, the aerosol-forming substrate or an aerosol-generating article comprising the aerosol-forming substrate and the shisha device cooperate to generate an aerosol.

A shisha device differs from other aerosol-generating devices in that the aerosol generated by a shisha device is drawn through a volume of liquid, typically water, before inhalation of the aerosol by a user. In more detail, when a user draws on a shisha device, volatile compounds released from a heated aerosol-forming substrate are drawn through an airflow conduit of the shisha device into a volume of liquid. The volatile compounds are drawn out of the volume of liquid into a headspace of the shisha device, in which the volatile compounds form an aerosol. The aerosol in the headspace is then drawn out of the headspace at a headspace outlet for inhalation by a user. The volume of liquid, typically water, acts to reduce the temperature of the volatile compounds, and may impart additional water content to the aerosol formed in the headspace of the shisha device. This process adds distinctive characteristics to the process of using a shisha device for a user, and imparts distinctive characteristics to the aerosol generated by the shisha device and inhaled by a user.

The shisha device may comprise a liquid cavity configured to contain a volume of liquid. The liquid cavity may comprise a head space outlet. The shisha device may include a vessel. The liquid cavity may be an interior volume of a vessel. The vessel may be configured to contain a liquid. The vessel may define the liquid cavity. The vessel may comprise the headspace outlet. The vessel may define a liquid fill level. For example, the vessel may comprise a liquid fill level demarcation. A liquid fill level demarcation is an indicator provided on the vessel to indicate the desired level to which the liquid cavity is intended to be filled with liquid. The headspace outlet may be arranged above the liquid fill level. The headspace outlet may be arranged above the liquid fill level demarcation. The vessel may comprise an optically transparent portion. The optically transparent portion may enable a user to observe the contents contained in the vessel. The vessel may be formed from any suitable material. For example, the vessel may be formed from glass or a rigid plastic material. In some embodiments, the vessel is removable from the rest of the shisha assembly. In some embodiments, the vessel is removable from an aerosol-generating portion of the shisha assembly. Advantageously, a removable vessel enables a user to fill the liquid cavity with liquid, empty the liquid cavity of liquid, and clean the vessel.

The vessel may be filled to a liquid fill level by a user. The liquid preferably comprises water. The liquid may comprise water infused with one or more of colorants and flavourants. For example, the water may be infused with one or both of botanical and herbal infusions.

The vessel may have any suitable shape and size. The liquid cavity may have any suitable shape and size. The headspace may have any suitable shape and size.

Typically, a shisha device according to this disclosure is intended to be placed on a surface in use, rather than being carried by a user. As such, a shisha device according to this disclosure may have a particular use orientation, or range of orientations, at which the device is intended to be oriented during use. Accordingly, as used herein, the terms ‘above’ and ‘below’ refer to relative positions of features of a shisha device or a shisha system when the shisha device or shisha system is held in a use orientation.

The shisha device may comprise an article cavity for receiving an aerosol-generating article. In some embodiments, the article cavity is arranged above the liquid cavity. In these embodiments, an airflow conduit may extend from the article cavity to below a liquid fill level of the liquid cavity. Advantageously, this may ensure that volatile compounds released from aerosol-forming substrate in the article cavity are delivered from the article cavity to the volume of liquid in the liquid cavity, rather than to the headspace above the liquid cavity. In these embodiments, the airflow conduit may extend from the aerosol cavity into the liquid cavity through the headspace in the liquid cavity above the liquid fill level, and into the volume of liquid below the liquid fill level. The airflow conduit may extend into the liquid cavity through a top or upper end of the liquid cavity.

In some embodiments, the article cavity is arranged below the liquid cavity. In these embodiments, a one-way valve may be arranged between the article cavity and the liquid cavity. The one-way valve may prevent liquid from the liquid cavity from entering the article cavity under the influence of gravity. In these embodiments, the one-way valve may be provided in an airflow conduit extending from the article cavity into the liquid cavity. In these embodiments, the airflow conduit may extend into the liquid cavity to below the liquid fill level. The airflow conduit may extend into the liquid cavity through a bottom end of the liquid cavity.

The shisha device may comprise a plurality of headspace outlets. For example, the shisha device may comprise two, three, four, five or six headspace outlets. Providing more than one headspace outlet may enable more than one user to draw aerosol from the liquid cavity at a time. In other words, providing a plurality of headspace outlets may enable a plurality of users to use the shisha device simultaneously

The aerosol-forming substrate may be a shisha aerosol-forming substrate. A shisha aerosol-forming substrate may also be referred to in the art as hookah tobacco, tobacco molasses, or simply as molasses. A shisha aerosol-forming substrate may be relatively high in sugar, compared to conventional combustible cigarettes or tobacco based consumable items intended to be heated without burning to simulate a smoking experience.

In some preferred embodiments, the aerosol-forming substrate is in the form of a suspension. For example, the aerosol-forming substrate may include molasses. As used herein, “molasses” means an aerosol-forming substrate composition comprising a suspension having at least about 20 percent by weight of sugar. For example, the molasses may include at least about 25 percent by weight of sugar, such as at least about 35 percent by weight of sugar. Typically, the molasses will contain less than about 60 percent by weight of sugar, such as less than about 50 percent by weight of sugar.

Preferably, the aerosol-forming substrate used in the shisha system is a shisha substrate. As used herein, a “shisha substrate” refers to an aerosol-forming substrate composition comprising at least about 20 percent by weight of sugar. A shisha substrate may comprise molasses. A shisha substrate may comprise a suspension having at least about 20 percent by weight of sugar.

The aerosol-forming substrate preferably includes nicotine and at least one aerosol former. In some embodiments, the aerosol former is glycerine or a mixture of glycerine and one or more other suitable aerosol formers, such as those listed above. In some embodiments, the aerosol-forming is propylene glycol.

The aerosol-forming substrate may include other additives and ingredients, such as flavourants. In some examples, the aerosol-forming substrate includes one or more sugars in any suitable amount. Preferably, the aerosol-forming substrate includes invert sugar. Invert sugar is a mixture of glucose and fructose obtained by splitting sucrose. Preferably, the aerosol-forming substrate includes between about 1 percent and about 40 percent sugar, such as invert sugar, by weight. In some example, one or more sugars may be mixed with a suitable carrier such as cornstarch or maltodextrin.

Any suitable amount of aerosol-forming substrate, such as molasses or tobacco substrate, may be provided in the aerosol-generating article. In some preferred embodiments, about 3 grams to about 25 grams of the aerosol-forming substrate is provided in the aerosol-generating article. The cartridge may include at least 6 grams, at least 7 grams, at least 8 grams, or at least 9 grams of aerosol-forming substrate. The cartridge may include up to 15 grams, up to 12 grams; up to 11 grams, or up to 10 grams of aerosol-forming substrate. Preferably, from about 7 grams to about 13 grams of aerosol-forming substrate is provided in the aerosol-generating article.

In some preferred embodiments, the aerosol-forming substrate may comprise tobacco, sugar and an aerosol-former. In these embodiments, the aerosol-forming substrate may comprise between 10 percent and 40 percent by weight of tobacco. In these embodiments, the aerosol-forming substrate may comprise between 20 percent and 50 percent by weight of sugar. In these embodiments, the aerosol-forming substrate may comprise between 25 percent and 55 percent by weight of aerosol-former.

It should be appreciated that features described in relation to an aerosol-generating device or an aerosol-generating article may also be applicable to an aerosol-generating system according to the disclosure.

It should also be appreciated that particular combinations of the various features described above may be implemented, supplied, and used independently.

Below, there is provided a non-exhaustive list of non-limiting examples. Any one or more of the features of these examples may be combined with any one or more features of another example, embodiment, or aspect described herein.

Ex1. A dielectrically heated aerosol-generating system, comprising:
an aerosol-forming substrate;
a first electrode and a second electrode; and
an aerosol-generating device comprising:
   a controller configured to connect to the first electrode and the second electrode,
wherein the first electrode and the second electrode form a capacitor with a portion of the aerosol-forming substrate;
wherein the controller is configured to supply an alternating voltage to the first electrode and the second electrode for dielectrically heating the aerosol-forming substrate; and
wherein the first electrode and the second electrode are configured to be spaced apart by a separation distance of between about 2 millimeters and about 9 millimeters.

Ex2. A dielectrically heated aerosol-generating system comprising:
an aerosol-forming substrate;
a first electrode and a second electrode; and
an aerosol-generating device comprising:
   a controller configured to connect to the first electrode and the second electrode,
wherein the first electrode and the second electrode form a capacitor with a portion of the aerosol-forming substrate;
wherein the controller is configured to supply an alternating voltage to the first electrode and the second electrode for dielectrically heating the aerosol-forming substrate; and
wherein the first electrode has a first length, and the second electrode has a second length, substantially the same as the first length;
wherein the first electrode and the second electrode are configured to be spaced apart in a direction perpendicular to the first length and the second length by a separation distance; and
wherein a ratio between the length of the first electrode and the separation distance is configured to be between about 10.5 and about 19.5.

Ex3. An aerosol-generating system according to Ex2, wherein the ratio between the length of the first electrode and the separation distance is configured to be between about 11 and about 19, preferably between about 11.5 and about 18.5, and more preferably between about 15.5 and about 17.5.

Ex4. An aerosol-generating system according to any one of Ex2 or Ex3, wherein the ratio between the length of the first electrode and the separation distance is configured to be about 16.6 or about 16.7.

Ex5. An aerosol-generating system according to any one of Ex2, Ex3 or Ex4, wherein the separation distance is configured to be between about 2 millimeters and about 9 millimeters.

Ex6. An aerosol-generating system according to any one of Ex1 to Ex5, wherein the separation distance is configured to be between about 2 millimeters and about 6 millimeters, preferably between about 2 millimeters and about 4 millimeters, and is more preferably configured to be about 3 millimeters.

Ex7. An aerosol-generating system according to any one of Ex1 to Ex6, wherein the first electrode has a first length, and the second electrode has a second length, substantially the same as the first length, and wherein the length of the first electrode is between about 20 millimeters and about 60 millimeters.

Ex8. An aerosol-generating system according to Ex7, wherein the length of the first electrode is between about 45 millimeters and about 55 millimeters, and is preferably about 50 millimeters.

Ex9. An aerosol-generating system according to any one of Ex1 to Ex8, wherein at least one of:
the first electrode has a thickness of between about 0.02 millimeters and about 2 millimeters, preferably between about 0.1 millimeters and about 1 millimeter, most preferably between about 0.3 millimeters and about 0.5 millimeters; and
the second electrode has a thickness of between about 0.02 millimeters and about 2 millimeters, preferably between about 0.1 millimeters and about 1 millimeter, most preferably between about 0.3 millimeters and about 0.5 millimeters.

Ex10. An aerosol-generating system according to any one of Ex1 to Ex9, wherein the first electrode comprises a first surface, and the second electrode has a second surface, and wherein at least one of:
the surface area of the first surface is between about 18 millimeters squared and about 22 millimeters squared, preferably between about 19 millimeters squared and about 20 millimeters squared; and
the surface area of the second surface is between about 18 millimeters squared and about 22 millimeters squared, preferably between about 19 millimeters squared and about 20 millimeters squared.

Ex11. An aerosol-generating system according to any one of Ex1 to Ex10, wherein at least one of the first electrode and the second electrode is gas permeable.

Ex12. An aerosol-generating system according to any one of Ex1 to Ex11, wherein the first electrode is substantially planar.

Ex13. An aerosol-generating system according to any one of Ex1 to Ex12, wherein the second electrode is substantially planar.

Ex14. An aerosol-generating system according to any one of Ex1 to Ex13, wherein the first electrode is substantially planar and extends substantially in a first plane, wherein the second electrode is substantially planar and extends substantially in a second plane, and wherein the second plane is substantially parallel to the first plane.

Ex15. An aerosol-generating system according to any one of Ex1 to Ex11, wherein the first electrode circumscribes the second electrode and optionally the first electrode and the second electrode are substantially co-axial.

Ex16. An aerosol-generating system according to any one of Ex15, wherein the first electrode has a substantially cylindrical shape.

Ex17. An aerosol-generating system according to Ex 15 or Ex16, wherein the second electrode has a substantially annular cylindrical shape.

Ex18. An aerosol-generating system according to any one of Ex 15 to Ex17, wherein the first electrode is annular, defining an internal passage.

Ex19. An aerosol-generating system according to Ex18, wherein the second electrode is disposed in the internal passage of the first electrode.

Ex20. An aerosol-generating system according to Ex1 to Ex19, wherein the aerosol-generating system is a shisha system, the aerosol-generating device is a shisha device and the aerosol-forming substrate is a shisha substrate, and wherein the shisha device comprises a liquid cavity configured to contain a volume of liquid, wherein the liquid cavity comprises a head space outlet and wherein the shisha device comprises an article cavity configured to receive the shisha substrate, the article cavity being in fluid communication with the liquid cavity.

Ex21. An aerosol-generating system according to any one of Ex1 to Ex20, wherein the frequency of the alternating voltage supplied to the first electrode and the second electrode is between 10 megahertz and 100 megahertz.

Ex22. An aerosol-generating system according to any one of Ex1 to Ex21, further comprising a power source configured to supply power of between about 10 Watts to about 60 Watts to the first electrode and the second electrode.

Ex23. An aerosol-generating system according to any one of Ex1 to Ex22 wherein the aerosol-generating system comprises an aerosol-generating article comprising the aerosol-forming substrate, wherein the aerosol-generating device is configured to receive the aerosol-generating article, and wherein the aerosol-generating article comprises both the first electrode and the second electrode.

Ex24. An aerosol-generating system according to any one of Ex1 to Ex22, wherein the aerosol-generating device comprises both the first electrode and the second electrode.

Ex25. An aerosol-generating system according to any one of Ex1 to Ex22, wherein the aerosol-generating system comprises an aerosol-generating article comprising the aerosol-forming substrate, wherein the aerosol-generating device is configured to receive the aerosol-generating article, wherein the aerosol-generating device comprises the first electrode and wherein the aerosol-generating article comprises the second electrode.

Ex26. An aerosol-generating system according to any one of Ex1 to Ex22, wherein the aerosol-generating system comprises an aerosol-generating article comprising the aerosol-forming substrate, wherein the aerosol-generating device is configured to receive the aerosol-generating article, wherein the aerosol-generating article comprises the first electrode and wherein the aerosol-generating device comprises the second electrode.

Ex27. An aerosol-generating article for use in a dielectrically heated aerosol-generating system according to any one of Ex1 to Ex23, the aerosol-generating article comprising:
a first electrode and a second electrode, the first electrode and the second electrode being spaced apart to form a substrate cavity; and
an aerosol-forming substrate disposed in the substrate cavity between the first electrode and the second electrode,
wherein the first electrode and the second electrode are spaced apart by a separation distance of between about 2 millimeters and about 9 millimeters.

Ex28. An aerosol-generating article for use in a dielectrically heated aerosol-generating system according to any one of Ex1 to Ex23, the aerosol-generating article comprising:
a first electrode and a second electrode, the first electrode and the second electrode being spaced apart to form a substrate cavity; and
an aerosol-forming substrate disposed in the substrate cavity between the first electrode and the second electrode,
wherein the first electrode has a first length, and the second electrode has a second length, substantially the same as the first length;
wherein the first electrode and the second electrode are spaced apart in a direction perpendicular to the first length and the second length by a separation distance; and
wherein a ratio between the length of the first electrode and the separation distance is between about 10.5 and about 19.5.

Ex29. An aerosol-generating article according to any one of Ex27 or Ex28, wherein the aerosol-forming substrate is circumscribed by a gas permeable wrapper.

Ex30. An aerosol-generating article according to Ex29, wherein the gas permeable wrapper is electrically insulating.

Ex31. An aerosol-generating article according to any one of Ex29 or Ex30, wherein the gas permeable wrapper is disposed between the first electrode and the second electrode.

Ex32. An aerosol-generating article according to Ex29, wherein at least one of the first electrode and the second electrode form at least a portion of the gas permeable wrapper.

Ex33. An aerosol-generating article according to any one of Ex29 to Ex32, wherein the gas permeable wrapper comprises at least one of a cellulosic material, or a plastic material, such as polypropylene or polyethylene.

Ex34. An aerosol-generating article according to any one of Ex27 to Ex33, wherein the aerosol-generating article is gas permeable in a transverse direction and substantially gas impermeable in a longitudinal direction, perpendicular to the transverse direction.

Ex35. An aerosol-generating article according to any one of Ex27 to Ex34, wherein the first electrode is substantially planar.

Ex36. An aerosol-generating article according to any one of Ex27 to Ex35, wherein the second electrode is substantially planar.

Ex37. An aerosol-generating article according to any one of Ex27 to Ex36, wherein the first electrode is substantially planar and extends substantially in a first plane, wherein the second electrode is substantially planar and extends substantially in a second plane, and wherein the second plane is substantially parallel to the first plane.

Ex38. An aerosol-generating article according to any one of Ex27 to Ex37, wherein the aerosol-generating article is substantially disc shaped.

Ex39. An aerosol-generating article according to any one of Ex27 to Ex38, wherein the first electrode is arranged at a first end of the aerosol-generating article, and the second electrode is arranged at a second end of the aerosol-generating article, opposite the first end.

Ex40. An aerosol-generating article according to any one of Ex27 to Ex34, wherein the first electrode circumscribes the second electrode and optionally the first electrode and the second electrode are substantially co-axial.

Ex41. An aerosol-generating article according to any one of Ex27 to Ex34, wherein the aerosol-generating article has a substantially cylindrical shape.

Ex42. An aerosol-generating article according to Ex41 having a substantially annular cylindrical shape.

Ex43. An aerosol-generating article according to Ex42, wherein the annular cylindrical article has a curved outer surface, wherein the annular cylindrical article has a passage extending through the article defined by an inner surface, and wherein one of the first electrode and the second electrode is arranged at the curved outer surface, and the other one of the first electrode and the second electrode is arranged at the inner surface.

Ex44. An aerosol-generating article according to Ex43, wherein the electrode arranged at the outer surface of the electrode substantially circumscribes the aerosol-forming substrate.

Ex45. An aerosol-generating article according to any one of Ex43 or Ex44, wherein the aerosol-generating article is gas permeable in a direction extending between the inner surface and the curved outer surface.

Ex46. An aerosol-generating article according to any one of Ex27 to Ex45, wherein the aerosol-generating article has a thickness of between about 2 millimeters and about 10 millimeters.

Ex47. An aerosol-generating article according to any one of Ex27 to Ex46, wherein the aerosol-forming substrate comprises at least one of: water, glycerol, and propylene glycol.

Ex48. An aerosol-generating article according to any one of Ex27 to Ex47, wherein the aerosol-generating article is a shisha article and the aerosol-forming substrate is a shisha substrate.

Ex49. A dielectrically heated aerosol-generating device for use in an aerosol-generating system according to any one of Ex1 to Ex22, comprising:
a first electrode and a second electrode;
a controller connected to the first electrode and the second electrode,
wherein the device is configured to receive an aerosol-forming substrate, the first electrode and the second electrode forming a capacitor with at least a portion of the aerosol-forming substrate, and wherein the controller is configured to supply an alternating voltage to the first electrode and the second electrode for dielectrically heating the aerosol-forming substrate; and
wherein the first electrode and the second electrode are spaced apart by a separation distance of between about 2 millimeters and about 9 millimeters.

Ex50. A dielectrically heated aerosol-generating device for use in an aerosol-generating system according to any one of Ex1 to Ex26, comprising:
a first electrode and a second electrode;
a controller connected to the first electrode and the second electrode,
wherein the device is configured to receive an aerosol-forming substrate, the first electrode and the second electrode forming a capacitor with at least a portion of the aerosol-forming substrate, and wherein the controller is configured to supply an alternating voltage to the first electrode and the second electrode for dielectrically heating the aerosol-forming substrate;
wherein the first electrode has a first length, and the second electrode has a second length, substantially the same as the first length;
wherein the first electrode and the second electrode are spaced apart in a direction perpendicular to the first length and the second length by a separation distance; and
wherein a ratio between the length of the first electrode and the separation distance is between about 10.5 and about 19.5.

Embodiments of the present disclosure will now be described, by way of example only, with reference to the accompanying drawings, in which:

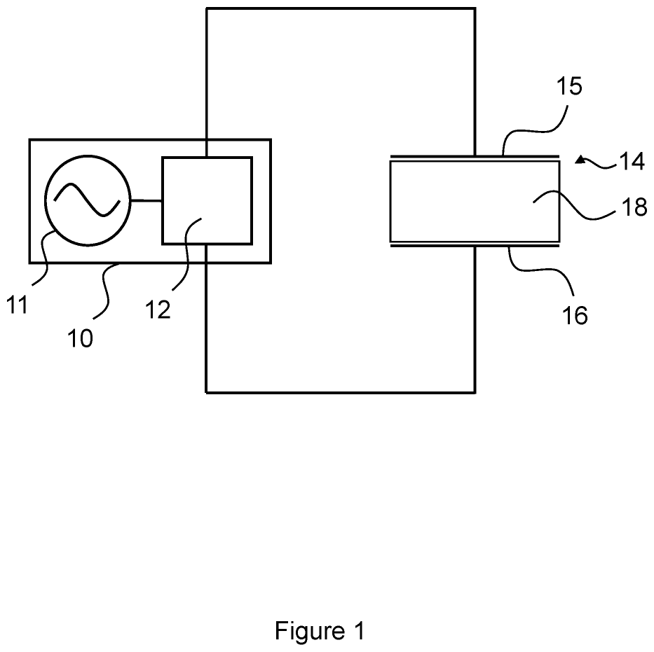

FIG. 1 is a schematic illustration of a dielectric heating system;

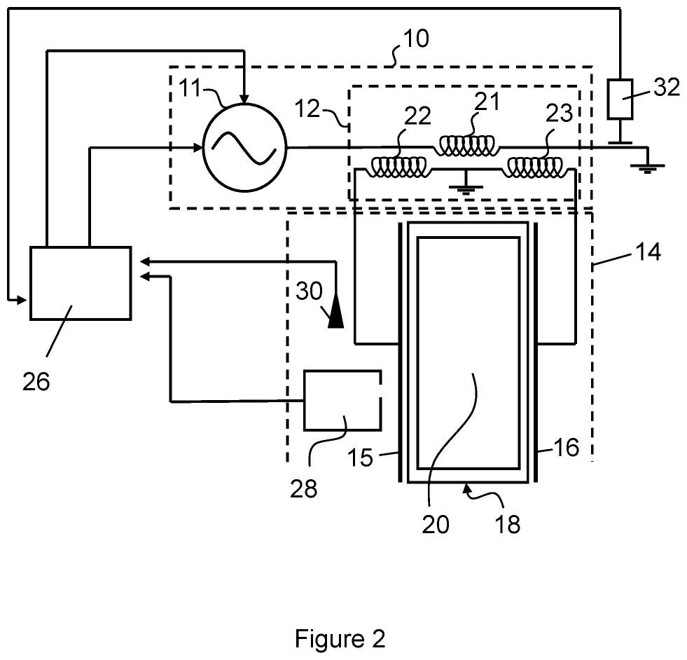

FIG. 2 is a schematic illustration of a closed-loop control system for an aerosol-generating system having a dielectric heating system according to embodiments of the disclosure;

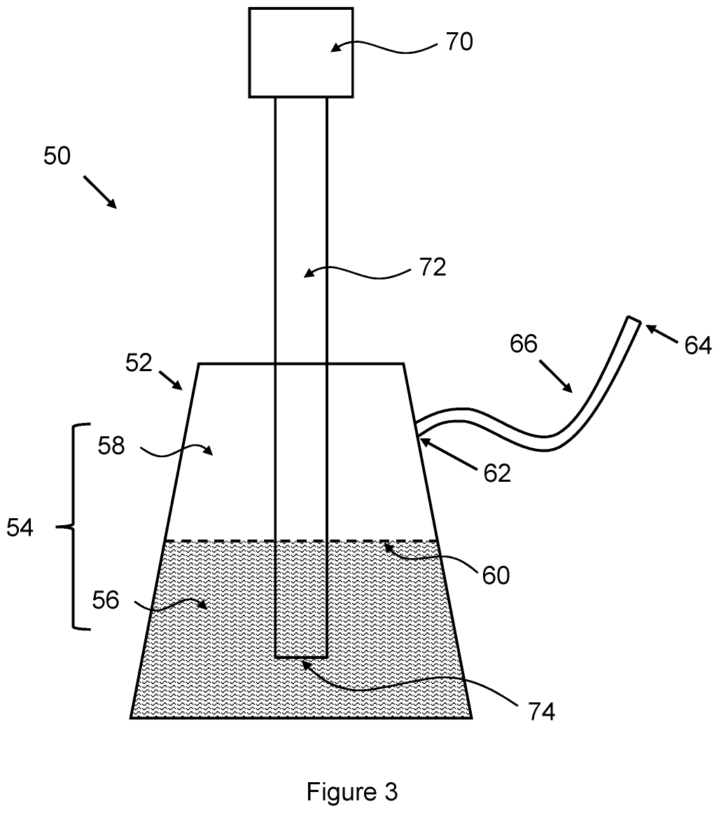

FIG. 3 is a schematic illustration of an embodiment of an aerosol-generating system having a dielectric heating system according to this disclosure, in which the aerosol-generating system is a shisha system;

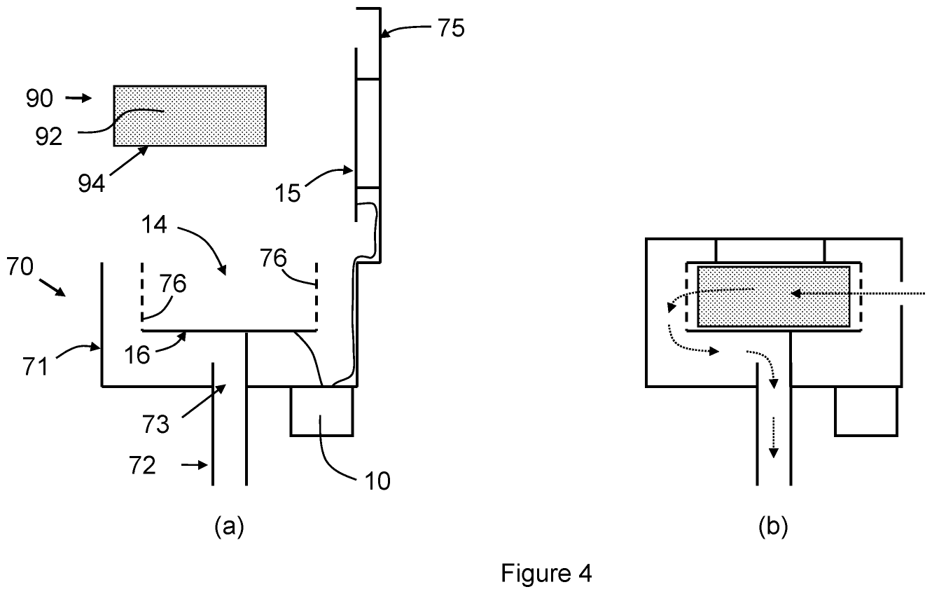

FIG. 4 is a schematic illustration of a heating unit of a shisha device and an aerosol-generating article configured for use with the shisha device according to an embodiment of the disclosure;

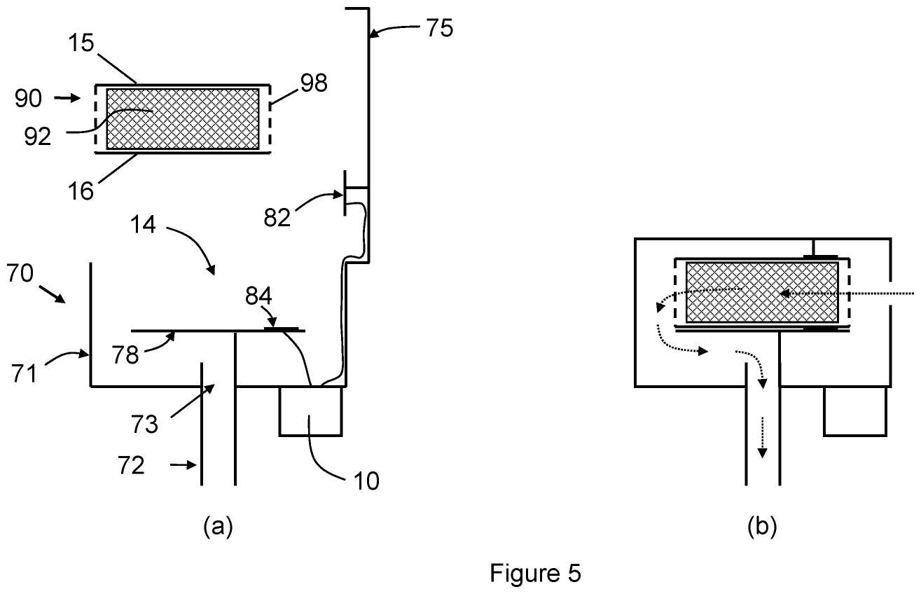

FIG. 5 is a schematic illustration of a heating unit of a shisha device and an aerosol-generating article according to an embodiment of the disclosure;

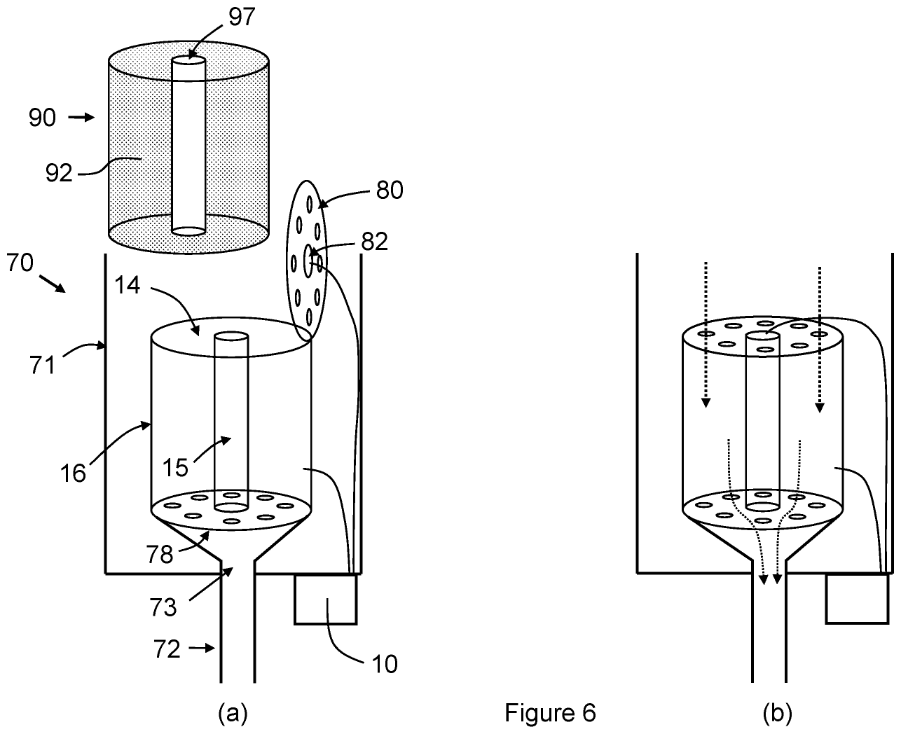

FIG. 6 is a schematic illustration of a heating unit of a shisha device and an aerosol-generating article configured for use with the shisha device according to an embodiment of the disclosure;

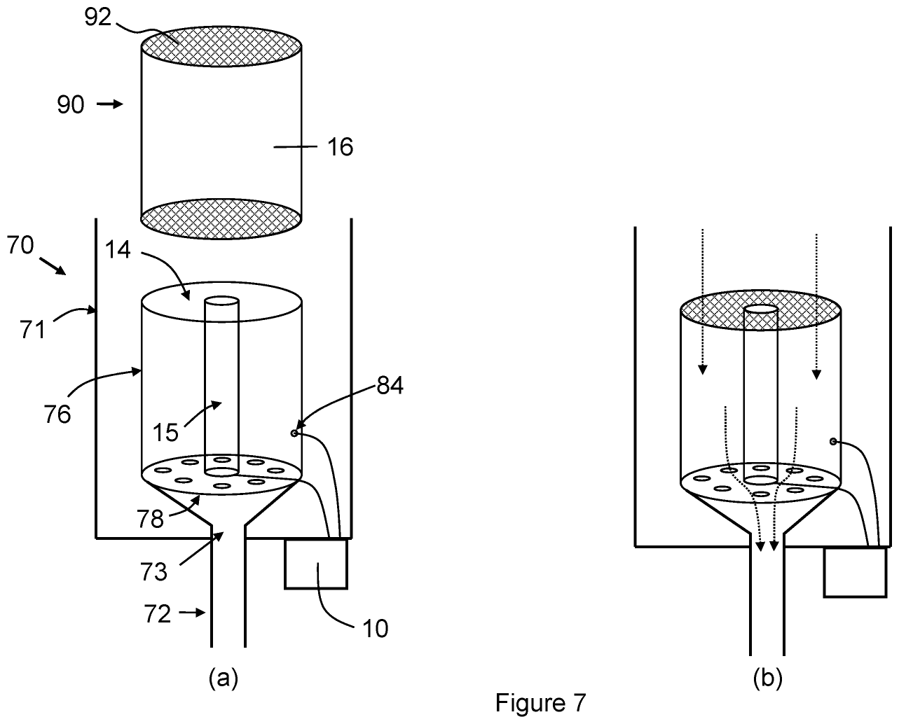

FIG. 7 is a schematic illustration of a heating unit of a shisha device and an aerosol-generating article configured for use with the shisha device according to an embodiment of the disclosure;

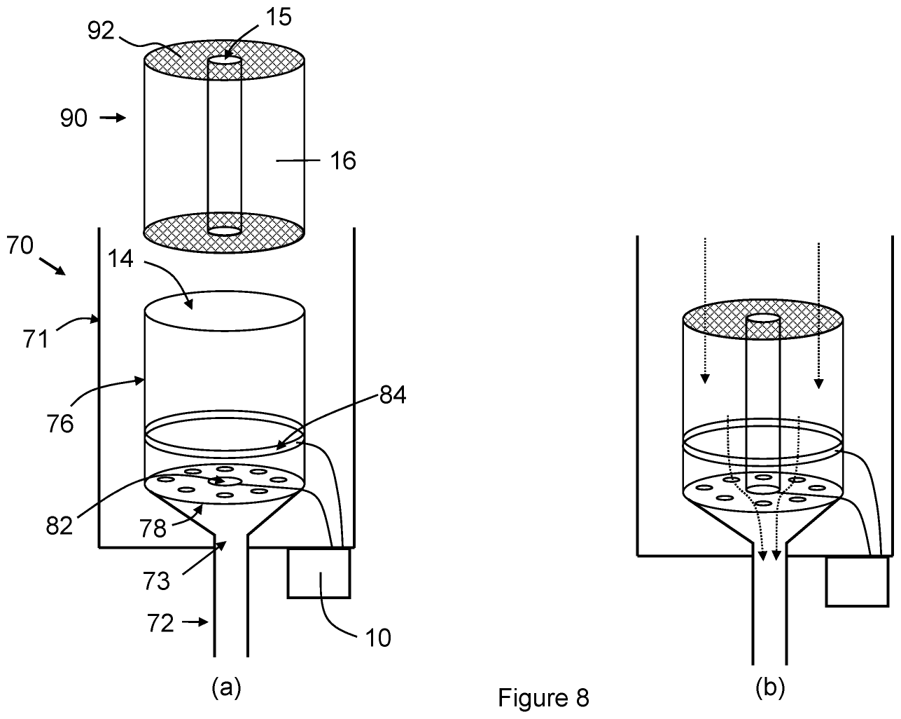

FIG. 8 is a schematic illustration of a heating unit of a shisha device and an aerosol-generating article configured for use with the shisha device according to an embodiment of the disclosure; and

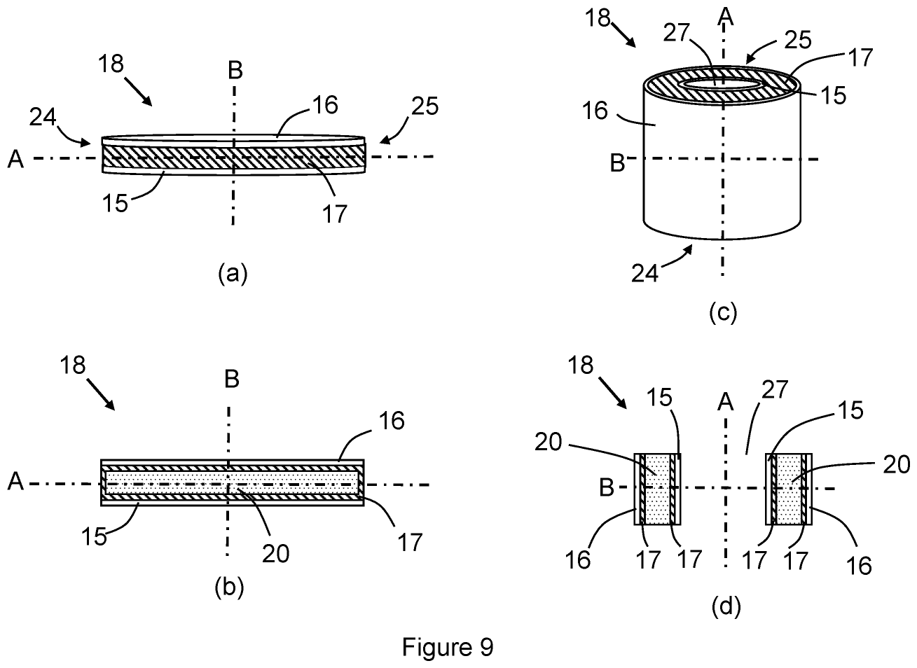

FIG. 9 is a schematic illustration of aerosol-generating articles according to embodiments of the disclosure, in which the aerosol-generating article comprises both the first electrode and the second electrode.

FIG. 1 is a schematic illustration of a system for dielectrically heating an aerosol-forming substrate using radio frequency (RF) electromagnetic radiation according to an embodiment of the present disclosure. The system comprises an oscillation circuit 10 including a radio frequency (RF) signal generator 11 and a phase shift network 12. The oscillation circuit is controlled by a controller (not shown). The system further comprises a first electrode 15 connected to a first output of the phase shift network 12, and a second electrode 16 connected to a second output of the phase shift network 12. The second electrode 16 is spaced apart from the first electrode 15 to define an article cavity 14 between the first electrode 15 and the second electrode 16. The article cavity 14 is configured to receive an aerosol-generating article 18. An aerosol-generating article 18, which is to be heated, is placed in the article cavity 14 and subjected to radio frequency electromagnetic radiation between the first electrode 15 and the second electrode 16. Polar molecules within the aerosol-generating article 18 align with the oscillating electromagnetic field and so are agitated by the electromagnetic field as it oscillates. This causes an increase in temperature of the aerosol-generating article 18. This kind of heating has the advantage that it is uniform throughout the aerosol-generating article 18 (provided that the polar molecules are uniformly distributed). It also has the advantage of reducing the likelihood of combustion of the substrate in contact with the first electrode and the second electrode compared to a conventional heating element that transfers heat to the substrate via conduction. In this embodiment, the first electrode 15 and the second electrode 16 are spaced apart by a separation distance of 3 millimeters, and the length of the first and second electrodes is about 40 millimeters, resulting in a ratio of the length of the first electrode to the separation distance of 13.3.

FIGS. 2 to 9 show different embodiments of shisha systems, shisha devices, and shisha aerosol-generating articles according to the disclosure. In all of the embodiments illustrated in FIGS. 2 to 9, the separation distance between the first and second electrodes is, or is configured to be, about 4 millimeters, and the first and second electrodes have a length of about 50 millimeters, resulting in a ratio of the length of the first electrode to the separation distance of about 12.5.

It will be appreciated that the separation distance between the first and second electrodes in any of these embodiments may be between about 2 millimeters and about 9 millimeters, in accordance with the disclosure, and the ratio between the length of the electrodes and the separation distance may be between about 10.5 and about 19.5.

It will also be appreciated that in some embodiments, the first electrode 15 and the second electrode 16 may be part of separate components of the system, for example, one of the first electrode 15 and the second electrode 16 may form a part of the article 18, and in these embodiments. In these embodiments, the separation distance is configured to be between about 2 millimeters and about 9 millimeters, and the ratio is configured to be between about 10.5 and about 19.5, when the aerosol-generating article is received in the article cavity.

FIG. 2 illustrates a control scheme that may be used in any of the embodiments described in FIGS. 3 to 8. As previously described, the system comprises a controller configured to control the oscillation circuit. In the example of FIG. 2, the oscillation circuit 10 comprises a RF signal generator 10 and a phase shift network 12 to split the signal from the RF signal generator 10 into two equal components, 180 degrees out of phase with each other.

A first output of the oscillation circuit 10 is passed to a first electrode 15. A second output 16 of the oscillation circuit 10 is passed to a second electrode 16. The first electrode 15 and the second electrode 16 are positioned on opposite sides of an article cavity 14, spaced apart by a separation distance of about 4 millimeters, such that the first electrode 15 and second electrode 16 are not in electrical contact and such that an aerosol-generating article 18 can be positioned in the space between the first electrode 15 and the second electrode 16. An aerosol-generating article 18 is positioned in the article cavity 14, in the space between the first electrode 15 and the second electrode 16.

In more detail, the phase shift network 12 comprises a transformer having a primary winding 21, a first secondary winding 22 and a second secondary winding 23. The primary winding 21 is connected at one end to an output of the RF signal generator 11 and at the other end to ground. One end of the first secondary winding 22 is connected to the first electrode 15 and one end of the second secondary winding 23 is connected to the second electrode 16. The other ends of the first secondary winding 22 and the second secondary winding 23 are connected together, and a centre tap between the first secondary winding 22 and the second secondary winding 23 is connected to ground. When power is supplied to the oscillation circuit 10, at any instant the voltages at the first electrode 15 and the second electrode 16 are substantially equal but opposite in polarity (i.e. 180 degrees out of phase with each other).

The controller comprises a microcontroller 26 that can control both the frequency and the power output of the RF signal generator 11. One or more sensors provide input to the microcontroller 26. The microcontroller 26 adjusts the frequency or the power output, or both the frequency and the power output, of the RF signal generator 11 based on the sensor inputs. In the example shown in FIG. 2, there is a temperature sensor 28 positioned to sense the temperature within the article cavity 14. A sampling antenna 30 may be provided in the article cavity 14 as an alternative, or in addition, to the temperature sensor 28. The sampling antenna 30 is configured as a receiver and can detect perturbation of the electromagnetic field in the article cavity 14, which is an indication of the efficiency of the energy absorption by the aerosol-forming substrate 20. A RF power sensor 32 is also provided to detect the power output from RF signal generator 11.

The microcontroller 26 receives signals from the RF power sensor 32, the temperature sensor 28 and the sampling antenna 30. The signals can be used to determine at least one of: whether the temperature is too low, whether the temperature is too high, if there is a fault, and if there is no substrate, or a substrate with inappropriate dielectric properties, in the article cavity 14.

Based on the determination made by the microcontroller 26, the frequency and power of the electromagnetic filed generated by the RF solid state transistor is adjusted or the electromagnetic filed is switched off. Typically, it is desirable to provide for a stable and consistent volume of aerosol, which means maintaining the aerosol-forming substrate within a particular temperature range. However, the desired target temperature may vary with time as the composition of the aerosol-forming substrate changes and the temperature of the surrounding system changes. Also, the dielectric properties of the aerosol-forming substrate change with temperature and so the electromagnetic field may need to be adjusted as temperature increases or decreases.

The embodiments described with reference to FIGS. 3 to 9 use the basic heating and control principles illustrated in FIGS. 1 and 2.

FIG. 3 is a schematic illustration of a shisha system according to an embodiment of this disclosure. The principles of this disclosure are applicable to dielectrically heated aerosol-generating systems in general, however, a shisha system has been chosen for illustrative purposes.

The shisha device 50 comprises a vessel 52 defining a liquid cavity 54. The vessel 52 is configured to retain a volume of liquid in the liquid cavity 54, and is formed from a rigid, optically transparent material, such as glass. In this embodiment, the vessel 52 has a substantially frustoconical shape, and is supported in use at its wide end on a flat, horizontal surface, such as a table or shelf. The liquid cavity 54 is divided into two sections, a liquid section 56 for receiving a volume of liquid, and a headspace 58 above the liquid section 58. A liquid fill level 60 is positioned at the boundary between the liquid section 56 and the headspace 58, the liquid fill level 60 being demarcated on the vessel 52 by a dashed line marked on an outer surface of the vessel 52. A headspace outlet 62 is provided on a side wall of the vessel 52, above the liquid fill level 60. The headspace outlet 62 enables fluid to be drawn out of the liquid cavity 54 from the headspace 58. A mouthpiece 64 is connected to the headspace outlet 62 by a flexible hose 66. A user may draw on the mouthpiece 64 to draw fluid out of the headspace 58 for inhalation.

The shisha device 50 further comprises a heating unit 70 comprising an oscillator circuit in accordance with the present disclosure. Examples of different heating units will be discussed in more detail below with reference to FIGS. 4, 5, 6, 7 and 8. The heating unit 70 is arranged above the vessel 52 by an airflow conduit 72. In this embodiment, the heating unit 70 is supported above the vessel 52 by the airflow conduit 72, however, it will be appreciated that in other embodiments the heating unit 70 may be supported above the vessel 52 by a housing of the shisha device or another suitable support. The airflow conduit 72 extends from the heating unit 70 into the liquid cavity 54 of the vessel 52. The airflow conduit 72 extends through the headspace 58, and below the liquid fill level 60 into the liquid section 58. The airflow conduit 72 comprises an outlet 74 in the liquid section 56 of the liquid cavity 54, below the liquid fill level 60. This arrangement enables air to be drawn from the heating unit 70 to the mouthpiece 64. Air may be drawn from an environment external to the device 50, into the heating unit 70, through the heating unit 70, though the airflow conduit 72 into the volume of liquid in the liquid section 56 of the liquid cavity 54, out of the volume of liquid into the headspace 58, and out of the vessel from the headspace 58 at the headspace outlet 62, through the hose 66 and to the mouthpiece 64.

In use, a user may draw on the mouthpiece 64 of the shisha device 50 to receive aerosol from the shisha device 50. In more detail, an aerosol-generating article comprising an aerosol-forming substrate can be positioned in an article cavity within the heating unit 70 of the shisha device 50. The heating unit 70 may be operated to heat the aerosol-forming substrate within the aerosol-generating article and release volatile compounds from the heated aerosol-forming substrate. When a user draws on the mouthpiece 64 of the shisha device 50, the pressure within the shisha device 50 is lowered, which draws the released volatile compounds from the aerosol-forming substrate out of the heating unit 70 and into the airflow conduit 72. The volatile compounds are drawn out of the airflow conduit 72 at the outlet 74, into the volume of liquid in the liquid section 56 of the liquid cavity 54. The volatile compounds cool in the volume of liquid and are released into the headspace 58 above the liquid fill level 60. The volatile compounds in the headspace 58 condense to form an aerosol that is drawn out of the headspace at the headspace outlet 62 and to the mouthpiece 64 for inhalation by the user.

FIG. 4 shows schematic illustrations of a heating unit 70 of the shisha device 50 of FIG. 3 in combination with an aerosol-generating article 90, forming a shisha system according to an embodiment of this disclosure. FIG. 4a shows the heating unit 70 and the aerosol-generating article 90 before insertion of the aerosol-generating article 90 into an article cavity 14 of the heating unit 70. FIG. 4b shows the aerosol-generating article 90 received in the article cavity 14 of the heating unit 70.

As shown in FIG. 4a, the heating unit 70 comprises an external housing 71. The external housing 71 forms a cylindrical tube that is open at one end for insertion of the aerosol-generating article 90, and is substantially closed at the opposite end. In this embodiment, the external housing 71 is formed from a material that is opaque to RF electromagnetic radiation, such as aluminium. However, it will be appreciated that the housing 71 does not need to be formed from a material that is opaque to RF electromagnetic radiation, but rather in some embodiments may be formed from a material that is substantially transparent to RF electromagnetic radiation, such as a ceramic material or a plastic material.

A closure 75 is moveable over the open end of the external housing 71 of the heating unit 70 to substantially close the open end. In this position, the external housing 71 and the closure 75 define a heating unit cavity. The closure 75 comprises an external housing similar to the external housing 71 of the heating unit, formed from the same material opaque to the RF electromagnetic field and sized and shaped to align and engage with the external housing 71 to close the open end. The closure 75 is rotatably connected to the external housing 71 by a hinge, and is rotatable between an open position, as shown in FIG. 4a, and a closed position, as shown in FIG. 4b. When the closure 75 is in the open position, the open end of the external housing 71 is open for insertion of an aerosol-generating article 90 into the heating unit cavity, and for removal of the aerosol-generating article 90 from the heating unit cavity. When the closure 75 is in the closed position, the heating unit cavity is surrounded by material that is opaque to a RF electromagnetic field, such that a RF electromagnetic field is unable to propagate from the heating unit cavity.

A side wall of the external housing 71 comprises an air inlet (shown in FIG. 4b), for enabling ingress of ambient air into the heating unit cavity.

The heating unit 70 is arranged above the vessel 52 of the shisha device 50 on the airflow conduit 72. The airflow conduit 72 extends into the heating unit cavity and is fixedly attached to the substantially closed end of the external housing 71 of the heating unit 70. It will be appreciated that in other embodiments, the heating unit 70 may be removably attached to the airflow conduit 72, such that the heating unit 70 may be removed for cleaning or replacement if necessary.

An article cavity 14 is defined within the heating unit cavity, for receiving the aerosol-generating article 90. The article cavity 14 is defined by a first electrode 15, a second electrode 16, opposite the first electrode 15, and a side wall 76 extending between the first electrode 15 and the second electrode 16. The article cavity 14 is configured to receive the aerosol-generating article 90, and has a shape and size that is complementary to the aerosol-generating article 90. The first electrode 15 and the second electrode 16 are substantially identical planar electrodes with a substantially circular shape. The first electrode 15 is secured to an inner surface of the closure 15, such that the first electrode 15 moves with the closure 75, and the second electrode 16 and side wall 76 are supported in the heating unit cavity by the airflow conduit 72. The second electrode 16 forms a base of the article cavity 14, the side wall 76 forms a side wall of the article cavity 14, and the first electrode 15 forms a top wall of the article cavity 14 when the closure 75 is in the closed position. The side wall 76 is formed from an electrically insulative material, in this embodiment a ceramic material, such as PEEK. Accordingly, the side wall 76 ensures that the first electrode 15 and the second electrode 16 do not come into electrical contact with each other.

The side wall 76 of the article cavity 14 is gas permeable, having slots formed therein to enable air to flow through the article cavity 14, from one side to the other, as shown in FIG. 4b. Accordingly, the heating unit 70 is configured such that air may be drawn into the heating unit cavity through the air inlet, through the article cavity 14 through the slots in the side wall 76 of the article cavity 14, and from the heating unit cavity into the airflow conduit 72, through the opening 73. It will be appreciated, however, that the airflow through the article cavity is not restricted to that illustrated in FIG. 4b. For example, in other embodiments, the first electrode 15 and the second electrode 16 may be gas permeable and the side wall 76 of the article cavity may be substantially gas impermeable. Therefore, air may be drawn into the heating unit 70 through the air inlet, then through the article cavity 14 through the first electrode 15 and the second electrode 16, and from the heating unit cavity into the airflow conduit 72, through the opening 73.

The heating unit 70 further comprises an oscillation circuit 10. The oscillation circuit 10 is connected to a power supply (not shown) and a controller (not shown) of the shisha device, the controller being configured to control the supply of power from the power supply to the oscillation circuit 10. In this embodiment, the power supply is a rechargeable lithium-ion battery, and the shisha device 50 comprises a power connector that enables the shisha device 50 to be connected to a mains power supply for recharging the power supply. Providing the shisha device 50 with a power supply, such as a battery, enables the shisha device 50 to be portable and used outdoors or in locations in which a mains power supply is not available.

The first electrode 15 is electrically connected to the oscillation circuit 10 by a flexible circuit. The second electrode 16 is also electrically connected to the oscillation circuit 10.

The aerosol-generating article 90 comprises an aerosol-forming substrate 92. In this embodiment, the aerosol-forming substrate 92 is a shisha substrate, comprising molasses and tobacco. The aerosol-forming substrate 92 is encased within a wrapper 94, formed from a gas permeable, electrically insulating material, such as tipping paper. The aerosol-generating article 90 has a substantially cylindrical shape, similar to a hockey puck, which is complimentary to the shape of the article cavity 14 of the shisha device 50.

As shown in FIG. 4b, when the aerosol-generating article 90 is received in the article cavity 14 of the heating unit 70, a circular base of the aerosol-generating article 90 contacts the second electrode 16 of the article cavity 14, and the sides of the aerosol-generating article 90 contact the side wall 76 of the article cavity 14. When the closure 75 is arranged in the closed position, the first electrode 15 and the second electrode 16 are configured to be spaced apart by a separation distance. In this embodiment, the separation distance is about 3 millimeters. Furthermore, when the closure 75 is arranged in the closed position, the circular top of the aerosol-generating article 90 contacts the first electrode 15 of the article cavity 14. In this arrangement, the first electrode 15, second electrode 16 and aerosol-generating article 90 form a capacitor, with the aerosol-forming substrate 90 defining the dielectric material between the first electrode 15 and the second electrode 16.

When a user draws on the mouthpiece 64 of the shisha device 50, air is drawn into the shisha device 50 through the air inlet of the external housing 71. An airflow path through the aerosol-generating article 90 and heating unit 70 is shown by the arrows in FIG. 4b. Air is drawn into the heating unit cavity through the air inlet of the external housing 71, and from the heating unit cavity into the aerosol-generating article 90 through the side wall 76 of the article cavity 14. Air is drawn through the aerosol-forming substrate 92 and back into the heating unit cavity through an opposite portion of the side wall 76 of the article cavity 14, and from the heating unit cavity into the airflow conduit 72 through the opening 73 in the external housing 71 of the heating unit 70.

In use, power is supplied to the oscillation circuit 10 from the power supply when a user activates the shisha device 50. In this embodiment, the shisha device is activated by a user pressing an activation button (not shown) provided on an external surface of the heating unit 70. It will be appreciated that in other embodiments, the shisha device may be activated in another manner, such as on detection of a user drawing on the mouthpiece 64 by a puff sensor provided on the mouthpiece 64. When power is supplied to the oscillation circuit 10, the oscillation circuit generates two substantially equal, out of phase RF electromagnetic signals with a frequency of between 1 Hz and 300 MHz. One of the signals is supplied to the first electrode 15, and the other signal is supplied to the second electrode 16.

The RF electromagnetic signals supplied to the first electrode 15 and the second electrode 16 establish an alternating RF electromagnetic field in the article cavity 14, which dielectrically heats the aerosol-forming substrate 90, which releases volatile compounds. As described above, the temperature in the article cavity 14 can be regulated using a feedback control mechanism. The temperature inside the article cavity 14 can be sensed, or another parameter indicative of the temperature inside the substrate cavity can be sensed, to provide a feedback signal to the controller of the shisha device 50. The controller is configured to adjust the frequency or amplitude, or both the frequency and the amplitude, of the RF electromagnetic field in order to maintain the temperature inside the article cavity 14 within a desired temperature range.

When a user draws on the mouthpiece 64 of the shisha device 50, the volatile compounds released from the heated aerosol-forming substrate 90 are entrained in the airflow through the aerosol-generating article 90 and are drawn out of the aerosol-generating article 90, through the heating unit 70 and into the airflow conduit 72 through the opening 73. From the airflow conduit 72, the volatile compounds are drawn through the shisha device 50 to and out of the mouthpiece 66 as described above.

FIG. 5 shows a heating unit 70 and aerosol-generating article 90 for a shisha device according to other embodiments of this disclosure. The heating unit 70 shown in FIG. 5 is substantially similar to the heating unit 70 shown in FIG. 4, and like reference numerals are used to represent like features. FIG. 5a shows the heating unit 70 and the aerosol-generating article 90 before insertion of the aerosol-generating article 90 into an article cavity 14 of the heating unit 70. FIG. 5b shows the aerosol-generating article 90 received in the article cavity 14 of the heating unit 70.

The heating unit 70 shown in FIG. 5 differs from the heating unit 70 shown in FIG. 4 in that the heating unit 70 shown in FIG. 5 does not comprise the first electrode 15 and the second electrode 16. Instead, in this embodiment the aerosol-generating article 90 comprises the first electrode 15 and the second electrode 16, and the heating unit 70 comprises a first electrical contact 82 and a second electrical contact 84.

The first electrical contact 82 is secured to an inner surface of the closure 75, in a similar position to the first electrical contact 15 of the embodiment of FIG. 4. The second electrical contact 84 is secured to a base 78 supported in the external housing 71 in a position similar to the second electrode 16 of the embodiment of FIG. 4. In this embodiments, the article cavity is merely defined by the base 78, and does not comprise a side wall. The first electrical contact 82 and the second electrical contact 84 are substantially identical, and comprise circular sheets of metal with a diameter that is significantly smaller than the diameter of the aerosol-generating article 90. The first electrical contact and the second electrical contact are electrically connected to the oscillation circuit 10.

In this embodiment, the aerosol-generating article 90 has a substantially similar cylindrical form to the aerosol-generating article 90 of the embodiment of FIG. 4. However, in this embodiment, the aerosol-forming substrate 92 is not wrapped in a wrapper, but rather is contained within a container. Circular bottom and top walls of the container are formed from an electrically conductive material, typically metal. The circular top wall forms the first electrode 15, and the circular bottom wall forms the second electrode 16. A side wall 98 extends between the periphery of the bottom wall and the periphery of the top wall, and is formed from an electrically insulative material, such as a plastics material, which ensures that the bottom and top walls do not come into electrical contact. A plurality of slots is provided in the side wall 98, to enable air to flow into and out of the aerosol-generating article 90.

As shown in FIG. 5b, when the aerosol-generating article 90 is received in the article cavity 14, and the closure 75 is rotated into the closed position, the first electrical contact 82 contacts the first electrode 15 and electrically connects the first electrode 15 to the oscillation circuit 10, and the second electrical contact 82 contacts the second electrode 15 and electrically connects the second electrode 15 to the oscillation circuit 10.

Also as shown in FIG. 5b, in use ambient air is drawn into the heating unit 70 through an air inlet, and into the aerosol-generating article 90 through the slots in the side wall 98. Air is drawn out of the aerosol-generating article 90 through the slots in the side wall 98 and into the airflow conduit 72, where the air passes into the vessel of the shisha device. In an alternative embodiment, the aerosol-generating article 90 does not comprise slots in the side wall 98, rather the first electrode 15 and the second electrode 16 are gas permeable and air is drawn into and out of the aerosol-generating article 90 through the first electrode 15 and the second electrode 16.

FIG. 6 shows a heating unit 70 for a shisha device and an aerosol-generating article 90, forming a shisha system according to another embodiment of this disclosure. The heating unit 70 and aerosol-generating article 90 shown in FIG. 6 are substantially similar to the heating unit 70 and aerosol-generating article 90 shown in FIG. 4, and like reference numerals are used to represent like features. FIG. 6a shows the heating unit 70 and the aerosol-generating article 90 before insertion of the aerosol-generating article 90 into an article cavity 14 of the heating unit 70. FIG. 6b shows the aerosol-generating article 90 received in the article cavity 14 of the heating unit 70.

The heating unit 70 shown in FIG. 6 differs from the heating unit 70 shown in FIG. 4 in that the first electrode 15 comprises an elongate, cylindrical electrode, and the second electrode 16 comprises an elongate, tubular electrode that circumscribes the first electrode 15.

The article cavity 14 is defined between the first electrode 15, the second electrode 16, and a base 78, forming an elongate annular cavity that is open at one end and substantially closed at the opposite end. The base 78 is formed from an electrically insulating material, such as PEEK, and comprises a plurality of slots to enable air to flow out of the article cavity 14. The base 78 is supported above a flared end of the airflow conduit 72, such that air flowing out of the article cavity 14 flows into the airflow conduit 72, as shown in FIG. 5b. In some embodiments, the flared end of the airflow conduit 72 is an integral part of the airflow conduit 72, however, in this embodiment, the flared end of the airflow conduit 72 is an integral part of the heating unit 70, and is removable from the airflow conduit with the heating unit 70.

The heating unit 70 shown in FIG. 6 also differs from the heating unit 70 shown in FIG. 4 in that the external housing 71 does not comprises a closure, but rather the article cavity 14 comprises a closure 80, which is hingedly mounted to the second electrode 16. The closure 80 is movable between an open position, as shown in FIG. 6a, to enable the aerosol-generating article to be inserted in the article cavity 14, and a closed position, as shown in FIG. 6b, for closing the open end of the article cavity 14. The closure 80 is similar to the base 78, in that it is formed from an electrically insulative material, such as PEEK, and comprises a plurality of slots to enable air to enter the article cavity 14 when the closure 80 is in the closed position. The closure 80 further comprises an electrical contact 82, centrally positioned on the closure, for contact with the first electrode 15 when the closure 80 is in the closed position, electrically connecting the first electrode 15 to the oscillation circuit 10. The electrical contact 82 is electrically connected to the oscillation circuit via a flexible circuit. The outer surface of the second electrode 16 is also electrically connected to the oscillation circuit 10.

In this embodiment, the aerosol-generating article 90 has an elongate, tubular shape that is complementary to the shape of the article cavity 14. In particular, the aerosol-forming substrate 92 comprises an inner passage 97 that is complementary in size and shape to the first electrode 15. When the aerosol-generating article 90 is received in the article cavity 14, the inner surface of the inner passage 97 of the aerosol-generating article 90 contacts the outer surface of the first electrode 15, and the outer surface of the aerosol-generating article 90 contacts the inner surface of the second electrode 16.

As shown in FIG. 6b, in use, ambient air is configured to enter the article cavity 14 through the closure 80, then through the aerosol-forming article 90, and exit the article cavity 14 through the base 78. In alternative embodiments, the first electrode 15 and the second electrode are gas permeable. The first electrode 15 has an inner passage that has an opening at the closure 80 end of the article cavity 14 and is substantially closed at the base 78 end of the article cavity 14. The closure 80 has an opening configured to correspond with the opening of the inner passage of the first electrode 15. Ambient air is configured to be drawn into the article cavity 14 through the inner passage of the first electrode 15, then in a radial or transverse direction through the first electrode 15 into the article cavity 14, and then exit the article cavity 14 through the second electrode 16 in a radial or transverse direction. The airflow is then directed to the airflow conduit 72 at the opening 73.

FIG. 7 shows a heating unit 70 for a shisha device and an aerosol-generating article 90, forming a shisha system according to another embodiment of this disclosure. The heating unit 70 and aerosol-generating article 90 shown in FIG. 7 are substantially similar to the heating unit 70 and aerosol-generating article 90 shown in FIG. 6, and like reference numerals are used to represent like features. FIG. 7a shows the heating unit 70 and the aerosol-generating article 90 before insertion of the aerosol-generating article 90 into an article cavity 14 of the heating unit 70. FIG. 7b shows the aerosol-generating article 90 received in the article cavity 14 of the heating unit 70.

The heating unit 70 shown in FIG. 7 differs from the heating unit 70 shown in FIG. 6 in that the heating unit 70 of FIG. 7 does not comprise the second electrode 16, but rather comprises a tubular side wall 76, formed from an electrically insulating material, such as PEEK, with an electrical contact 84 arranged at an inner surface of the side wall 76. The electrical contact 84 is a substantially point contact, electrically connected to the oscillation circuit 10.

The heating unit 70 shown in FIG. 7 differs from the heating unit 70 shown in FIG. 6 in that the heating unit 70 of FIG. 7 does not comprise a closure.

The aerosol-generating article 90 shown in FIG. 7 differs from the aerosol-generating article 90 shown in FIG. 6 in that the aerosol-generating article 90 of FIG. 7 comprises the second electrode 16, in the form of an electrically conductive wrapper circumscribing the cylindrical outer surface of the aerosol-forming substrate 92. In addition, the aerosol-generating article 90 of FIG. 7 does not comprise an inner passage. As such, the first electrode 15 is configured to penetrate the aerosol-forming substrate 92 when the aerosol-generating article 90 is received in the article cavity 14.

When the aerosol-generating article 90 is received in the article cavity 14, the second electrode 16 contacts the electrical contact 84 on the inner surface of the cylindrical side wall 76, and electrically connects the second electrode 16 to the oscillation circuit 10.

FIG. 8 shows a heating unit 70 for a shisha device and an aerosol-generating article 90, forming a shisha system according to another embodiment of this disclosure. The heating unit 70 and aerosol-generating article 90 shown in FIG. 8 are substantially similar to the heating unit 70 and aerosol-generating article 90 shown in FIG. 7, and like reference numerals are used to represent like features. FIG. 8a shows the heating unit 70 and the aerosol-generating article 90 before insertion of the aerosol-generating article 90 into an article cavity 14 of the heating unit 70. FIG. 8b shows the aerosol-generating article 90 received in the article cavity 14 of the heating unit 70.

The heating unit 70 shown in FIG. 8 differs from the heating unit 70 shown in FIG. 7 in that the heating unit 70 of FIG. 8 does not comprise the first electrode 15 or the second electrode 16, but rather comprises a first electrical contact 82 and a second electrical contact 84. The first electrical contact 82 is arranged centrally at the base 78, and is substantially similar to the electrical contact 82 on the closure 80 of the embodiment of FIG. 6. The second electrical contact 84 is a ring contact circumscribing the inner surface of the side wall 76.

The aerosol-generating article 90 shown in FIG. 8 differs from the aerosol-generating article 90 shown in FIG. 7 in that the aerosol-generating article 90 of FIG. 7 comprises the first electrode 15 and the second electrode 16. The first electrode 15 comprises an elongate, cylindrical electrode, extending centrally through the aerosol-forming substrate 92. The second electrode 16 comprises an electrically conductive wrapper circumscribing the cylindrical outer surface of the aerosol-forming substrate 92.

When the aerosol-generating article 90 is received in the article cavity 14, an end of the first electrode 15 of the aerosol-generating article 90 contacts the first electrical contact 82 at the base 78 of the article cavity 14, electrically connecting the first electrode 15 to the oscillation circuit 10, and the second electrode 16 of the aerosol-generating article contacts the second electrical contact 84 on the inner surface of the cylindrical side wall 76, electrically connecting the second electrode 16 to the oscillation circuit 10.

FIG. 9 is a schematic illustration of aerosol-generating articles according to embodiments of this disclosure which comprise both the first electrode and the second electrode. The aerosol-generating articles of FIG. 9 may be used in the systems previously described.

FIGS. 9a and 9b are schematic illustrations of a planar, disc shaped aerosol-generating article according to an embodiment of this disclosure. FIG. 9a shows a perspective view of the aerosol-generating article. FIG. 9b shows a cross-sectional view of the aerosol-generating article. The aerosol-generating article 18 comprises a first electrode 15 and a second electrode 16. In this embodiment, the first electrode 15 and the second electrode 16 are disc shaped, being substantially planar and having a circular shape. The first electrode 15 extends in a first plane and the second electrode 16 extends in a second plane, parallel to the first plane. The article 18 has a longitudinal axis A, and extends along the longitudinal axis A from a first end 24 to a second end 25. The first and second planes extend substantially parallel to the longitudinal axis A. In this embodiment, the electrodes have a length in the longitudinal direction of about 50 millimeters. In other words, the circular electrodes have a diameter of about 50 millimeters. The second electrode 16 is substantially parallel to the first electrode 15. The two electrodes 15, 16 are spaced apart in a transverse direction, along axis B, by a separation distance. The space in between the first and second electrodes 15, 16 forms a substrate cavity. In this embodiment, the separation distance between the first electrode 15 and the second electrode 16 is about 4 millimeters. An aerosol-forming substrate 20 is disposed in the substrate cavity between the first electrode 15 and the second electrode 16. The aerosol-forming substrate 20 is circumscribed by a gas permeable wrapper 17, as shown in FIG. 9b. Both the aerosol-forming substrate 20 and the gas permeable wrapper 17 are disposed between the first electrode 15 and the second electrode 16.

FIGS. 9c and 9d are schematic illustrations of an annular cylindrical aerosol-generating article according to an embodiment of this disclosure. FIG. 9c shows a perspective view of the aerosol-generating article. FIG. 9d shows a cross-sectional view of the aerosol-generating article. The aerosol-generating article 18 comprises an annular first electrode 15, and an annular second electrode 16 circumscribing the first electrode 15. The first and second electrodes 15, 16 are hollow tubes and are disposed co-axially, with the inner diameter of the second electrode 16 being larger than the outer diameter of the first electrode 15. The first electrode 15 and the second electrode 16 extend in a longitudinal direction, along axis A, from a first end 24 of the aerosol-generating article 18 to a second end 25 of the aerosol-generating article 18. In this embodiment, the first and second electrodes 15, 16 have a length along the longitudinal direction of about 50 millimeters. The aerosol-generating article 18 has a central passage 27 extending through the article 18 from the first end 24 of the article to the second end of the article 25. The central passage 27 is defined by an inner surface of the annular first electrode 15. The first electrode 15 and the second electrode 16 are spaced apart in a transverse or radial direction, along axis B, by a separation distance. The space between the first and second electrodes 15, 16 forms a substrate cavity. In this embodiment, the separation distance between the first electrode 15 and the second electrode 16 is about 4 millimeters. An aerosol-forming substrate 20 is disposed in the substrate cavity between the first electrode 15 and the second electrode 16. The aerosol-forming substrate 20 is circumscribed by a gas permeable wrapper 17, as shown in FIG. 9d. Both the aerosol-forming substrate 20 and the gas permeable wrapper 17 are disposed between the first electrode 15 and the second electrode 16.

It will be appreciated that the embodiments described above are exemplary embodiments only, and various other embodiments according with this disclosure are also envisaged.

1.-14. (canceled)

15. A dielectrically heatable aerosol-generating system, comprising:
an aerosol-forming substrate;
a first electrode and a second electrode; and
an aerosol-generating device comprising a controller configured to connect to the first electrode and the second electrode,
wherein the first electrode and the second electrode form a capacitor with a portion of the aerosol-forming substrate,
wherein the controller is further configured to supply an alternating voltage to the first electrode and the second electrode for dielectrically heating the aerosol-forming substrate, and
wherein the first electrode and the second electrode are configured to be spaced apart by a separation distance of between about 4 millimeters and about 9 millimeters.

16. A dielectrically heatable aerosol-generating system comprising:
an aerosol-forming substrate;
a first electrode and a second electrode; and
an aerosol-generating device comprising a controller configured to connect to the first electrode and the second electrode,
wherein the first electrode and the second electrode form a capacitor with a portion of the aerosol-forming substrate,
wherein the controller is further configured to supply an alternating voltage to the first electrode and the second electrode for dielectrically heating the aerosol-forming substrate,
wherein the first electrode has a first length, and the second electrode has a second length being substantially the same as the first length,
wherein the first electrode and the second electrode are configured to be spaced apart in a direction perpendicular to the first length and the second length by a separation distance, and
wherein a ratio between the first length of the first electrode and the separation distance is configured to be between about 15.5 and about 17.5.

17. The aerosol-generating system according to claim 16, wherein the ratio between the first length of the first electrode and the separation distance is configured to be about 16.6 or about 16.7.

18. The aerosol-generating system according to claim 16, wherein the separation distance is configured to be between about 2 millimeters and about 9 millimeters.

19. The aerosol-generating system according to claim 15, wherein the separation distance is configured to be between about 2 millimeters and about 6 millimeters.

20. The aerosol-generating system according to claim 15, wherein the separation distance is configured to be between about 3 millimeters.

21. The aerosol-generating system according to claim 15,
wherein the first electrode has a first length, and the second electrode has a second length substantially the same as the first length, and
wherein the first length of the first electrode is between about 20 millimeters and about 60 millimeters.

22. The aerosol-generating system according to claim 15,
wherein the first electrode has a first length, and the second electrode has a second length substantially the same as the first length, and
wherein the first length of the first electrode is about 50 millimeters.

23. The aerosol-generating system according to claim 15, wherein at least one of:
the first electrode has a thickness of between about 0.02 millimeters and about 2 millimeters, and
the second electrode has a thickness of between about 0.02 millimeters and about 2 millimeters.

24. The aerosol-generating system according to claim 15, wherein at least one of:
the first electrode has a thickness of between about 0.3 millimeters and about 0.5 millimeters, and
the second electrode has a thickness of between about 0.3 millimeters and about 0.5 millimeters.

25. The aerosol-generating system according to claim 15, wherein at least one of the first electrode and the second electrode is gas permeable.

26. The aerosol-generating system according to claim 15, wherein at least one of the first electrode and the second electrode is substantially planar.

27. The aerosol-generating system according to claim 15,
wherein the first electrode is substantially planar and extends substantially in a first plane,
wherein the second electrode is substantially planar and extends substantially in a second plane, and
wherein the second plane is substantially parallel to the first plane.

28. The aerosol-generating system according to claim 15, wherein the first electrode circumscribes the second electrode.

29. The aerosol-generating system according to claim 28,
wherein the first electrode is annular, defining an internal passage, and
wherein the second electrode is disposed in the internal passage of the first electrode.

30. The aerosol-generating system according to claim 15,
wherein the aerosol-generating system is a shisha system, the aerosol-generating device is a shisha device, and the aerosol-forming substrate is a shisha substrate,
wherein the shisha device comprises a liquid cavity configured to contain a volume of liquid,
wherein the liquid cavity comprises a head space outlet, and
wherein the shisha device further comprises an article cavity configured to receive the shisha substrate, the article cavity being in fluid communication with the liquid cavity.

31. An aerosol-generating article for a dielectrically heatable aerosol-generating system according to claim 15, the aerosol-generating article comprising:
a first electrode and a second electrode, the first electrode and the second electrode being spaced apart to form a substrate cavity; and
an aerosol-forming substrate disposed in the substrate cavity between the first electrode and the second electrode,
wherein the first electrode and the second electrode are spaced apart by a separation distance of between about 4 millimeters and about 9 millimeters.

32. An aerosol-generating article for a dielectrically heatable aerosol-generating system according to claim 15, the aerosol-generating article comprising:
a first electrode and a second electrode, the first electrode and the second electrode being spaced apart to form a substrate cavity; and
an aerosol-forming substrate disposed in the substrate cavity between the first electrode and the second electrode,
wherein the first electrode has a first length, and the second electrode has a second length substantially the same as the first length,
wherein the first electrode and the second electrode are spaced apart in a direction perpendicular to the first length and the second length by a separation distance, and
wherein a ratio between the first length of the first electrode and the separation distance is between about 15.5 and about 17.5.
